(19) United States
(12) Patent Application Publication
(10) Pub. No.: US 2026/0316959 A1
(43) Pub. Date: Oct. 15, 2026

(54) ENGINE INSPECTION SYSTEMS AND METHODS

(71) Applicants: General Electric Company, Evendale, OH (US); Oliver Crispin Robotics Limited, Altrincham (GB)

(72) Inventors: Vamshi Krishna Reddy Kommareddy, Hyderabad (IN); Biswajit Medhi, Bangalore (IN); Andrew Crispin Graham, Badminton (GB); James Vradenburg Miller, Clifton Park, NY (US); Michael E. Eriksen, Milford, OH (US); Tim Henri Ann Francois, Emerson’s Green (GB); Teddy Mulenga Ng'onga, Bristol (GB); Adam Luke Gilbert, Bristol (GB); Adam Philip Mallion, Bath (GB); Alain Warren, St-Joachim-de-Shefford (CA); Antoine Lizotte, Bromont (CA); Arman Kaplan, London (GB); Benjamin Peter Roper, Hambrook (GB); Jonathan Downing, Cincinnati, OH (US); Justin Egan, Lawrenceburg, IN (US); Marc-André Marois, Granby (GB); Ross Lewis Thorpe, Newport (GB); Shaopeng Liu, Clifton Park, NY (US); Steeves Bouchard, Granby (CA); Viktor Holovashchenko, Clifton Park, NY (US); Walter V. Dixon, Delanson, NY (US)

(21) Appl. No.: 19/483,454

(22) PCT Filed: Jun. 10, 2024
(86) PCT No.: PCT/US2024/033237

§ 371 Date: Nov. 11, 2025

(30) Foreign Application Priority Data
Jun. 12, 2023 (IN) 202311040040

(51) Int. Cl. B64F 5/60; F01D 21/00

(52) U.S. Cl. CPC B64F 5/60; F01D 21/003; F05D 2260/80

(57) ABSTRACT

An aircraft component inspection system is provided. The system includes an image capture system including: an image sensor system, a positioning system, and a processor configured to determine an inspection recipe based at least on an identifier associated with a component of an aircraft being inspected, identify a plurality of locations for performing image capture during an inspection workflow based on the inspection recipe, provide machine instruction to the positioning system to position the image sensor system relative to the component based on the plurality of locations, cause the image sensor system to capture images at the plurality of locations, and store the images with capture location data in an inspection data database.

This application claims priority to Indian Patent Application No. 202311040040, filed on Jun. 12, 2023, with the Indian Patent Office. The entire contents of the aforementioned application are incorporated herein by reference for all purposes.

### TECHNICAL FIELD

These teachings relate generally to inspection systems and more particularly to systems and methods for the inspection of aircraft components, including jet engines.

### BACKGROUND

Aircraft engines undergo maintenance, repair, and overhaul (MRO) when they are sent to the original equipment manufacturer (OEM) or to partnership MRO providers. During the initial stage of MRO, a workshop may document the internal and external condition of the engine as received. Generally, pictures or videos of the externals may be taken by a shop resource using available point-and-shoot frame cameras that may result in inconsistent image capturing that varies from engine to engine and shop to shop. Significant time may also be spent capturing these frames and documenting them manually for record keeping and communicating with a customer should missing components or other issues be found during inspection.

MRO for a unit such as an engine may rely heavily on humans to visually inspect the inbound unit to assess the condition of the unit, plan the maintenance work scope, and assess the quality of images or other data. The unconstrained, human-controlled acquisition of data to support this evaluation may lead to inconsistent interpretations or produce an inadequate and incomplete digital record, making condition assessment significantly more difficult and less effective. Tools such as menu driven inspection (MDI), may help to improve the consistency of data, but still produce significant variation in the quality and coverage needed for an optimized shop experience. Acquiring a complete digital record of the inbound unit may also be difficult when a human is the intermediary controlling the acquisition and interpreting the data to assess condition. Many of the assessment decisions may be made at the time of inspection and without access to a complete digital record. Any follow-up questions may involve a re-inspection of the unit due to the lack of a complete digital record.

### BRIEF DESCRIPTION OF DRAWINGS

Various needs are at least partially met through provision of the systems and methods for inspection guidance and data capture described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 comprises a block diagram of an inspection system in accordance with various embodiments.

FIG. 2 comprises a flow diagram of an inspection method in accordance with various embodiments.

FIG. 3 comprises a flow diagram of an inspection method in accordance with various embodiments.

FIG. 4 comprises a flow diagram of a model training process in accordance with various embodiments.

FIG. 5 comprises a flow diagram of a condition assessment method in accordance with various embodiments.

FIG. 6 comprises a flow diagram of an inspection method in accordance with various embodiments.

FIGS. 7A, 7B, 7C, 7D, 7E, 7F, 7G, and 7H comprise schematic diagrams of exemplary positioning systems in accordance with various embodiments.

FIG. 8 comprises an exemplary image capture system in accordance with various embodiments.

FIG. 9 comprises a flow diagram of an inspection method in accordance with various embodiments.

FIG. 10 comprises a flow diagram of an inspection method in accordance with various embodiments.

FIGS. 11A, 11B, and 11C comprise schematic diagrams of an image capture system and images acquired therefrom in accordance with some embodiments.

FIG. 12 comprises a flow diagram of an inspection method in accordance with various embodiments.

FIG. 13 comprises a flow diagram of an inspection method in accordance with various embodiments.

FIG. 14 comprises a schematic diagram of features of an exemplary inspection user interface in accordance with various embodiments.

FIGS. 15A, 15B, and 15C comprise exemplary inspection user interfaces in accordance with various embodiments.

FIG. 16 comprises an exemplary user input device in accordance with some embodiments.

FIG. 17 comprises an exemplary user input device in accordance with some embodiments.

FIG. 18 comprises an exemplary computer system for the inspection system in accordance with various embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Reference now will be made in detail to embodiments of the present disclosure, one or more examples of which are illustrated in the drawings. Each example is provided by way of explanation of the present disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first,” “second,” and “third” may be used interchangeably to distinguish one component from another and are not intended to signify location or importance of the individual components.

The terms “coupled,” “fixed,” “attached to,” “integrated,” and the like refer to both direct coupling, fixing, or attaching, as well as indirect coupling, fixing, or attaching through one or more intermediate components or features, unless otherwise specified herein.

The singular forms “a,” “an,” and “the” include plural referents unless the context clearly dictates otherwise.

In some aspects, the inspection systems and methods disclosed herein standardize engine configuration and condition gathering, analysis, reporting, and storage of data on engine configuration and condition. The inspection systems can include one or more application programming interfaces (API)s that may be used on a mobile device. The inspection systems and methods disclosed herein can be applied to the initial inspection for engine maintenance, repair, and overhaul/operation (MRO). Engine MRO may include all steps and actions involved to keep or restore an engine to its working condition. Maintenance may include preventative, corrective, and predictive maintenance for an engine.

In some aspects, the inspection systems include one or more tools to capture images or other data on engine hardware using a standardized template to guide an operator (using visual overlay, reference images, or artificial intelligence (AI) guidance), or automation (robot), to provide a record of the engine configuration. The record may cover the condition of the whole exterior of the engine (or other scope such as a module, component, etc.). The tools may include a robotic inspection system. Operation of a robotic inspection system may be commanded and supervised remotely, enabling appropriate expert review and unattended local operation.

The manual guidance “recipe” or automated survey program for the inspection system may be based on the engine type or on an electronic serial number (ESN). The recipe may be shared between multiple devices, and may include a mix of manual and automated functionality, where appropriate. The recipe may have deep link functionality to the engine shop manual (ESM) or aircraft maintenance manual (AMM), to provide inspection requirements, limits, part numbers and/or descriptions, assembly and/or disassembly instructions, torque values, etc. Recipes and/or templates may also be defined for ad-hoc purposes, for example, by a user or a shop.

The tool of the inspection system may include analytics to check the image exposure, blur, shake, etc., to ensure captured images meet the intent.

The tool of the inspection system may enable capture of part number markings, serial numbers, or other data plate entries. In one approach, the inspection system may capture an image of a data plate associated with the engine or a component thereof and the inspection system may use optical character recognition to extract information from the data plate.

The images captured by the inspection system may then be used to determine a disposition of the hardware. The images may be uploaded to an online portal and used to produce reports documenting the findings. The images, analytics, and/or disposition may be used to set and/or adjust the engine work scope. In some examples the work scope may be adjusted in real time based on the images, analytics, and/or disposition determined by the inspection system. For example, if a damage detail is found on a component, the discovery may drive a component-specific workflow. The inspection system may be connected to logistics infrastructure to assist with material ordering for engine repair material, required tooling and for engine test purposes (e.g., missing accessories), or for the scheduling of labor or repair or testing.

A user interface associated with the inspection system (e.g., an inspection portal) may allow inspectors and end users (e.g., customers, support functions, logistics, finance, engineering, etc.) to access the data captured during the inspection. In some approaches, the presentation and display of data on the user interface may be customized to the particular end user. Data may also be accessible via web portals, dedicated terminals, or other devices. Data storage may be local (e.g., at a shop) and/or cloud-based (e.g., via a data lake, a cloud computing service such as Amazon Web Services (AWS) or LDP-media). Further data acquired or generated by the inspection system may be integrated into an enterprise resource planning (ERP) system (e.g., SAP). Data communications for the inspection system may be wireless (e.g., Wi-Fi, Bluetooth) and/or wired.

In some aspects, the processes disclosed herein may improve end-to-end visibility of the inspection process and disposition of the engine throughout the shop visit and on-wing. The inspection system may be used by customers to record engine condition on-wing and near-wing (e.g., before shipment), by logistics partners (e.g., on loading, unloading, delivery), and/or by shops (e.g., engine manufacturers, suppliers, and third parties involved at various inspection stages and/or locations).

Images acquired by the inspection system may be tagged with metadata based on the template and/or recipe and may be searchable through the portal (LDP-media). Thus, the engine, module, and component identity can be used to recall all images containing the search item to check condition at various points of contact and various stages of inspection.

In some aspects, inspection systems are provided herein that enable a standardized process for collecting, processing, and reviewing inspection data related to MRO activities. The inspection systems may include a central computer having modules related to one or more of the following to streamline and consolidate MRO activities: inspection recipe determination, image validation, component identification, component condition assessment, work scope planning, inspection reporting/documentation, and automation controls. The inspection systems may further include an inspection user interface (UI) through which internal and external inspection of the engine may be managed, analyzed, and consumed. The UI may provide multilevel data classification for analysis and report generation, for example, at the asset level, component level, customer level, region level, etc. The UI may be tailored to various user groups including MRO work scoping, logistics, customers, suppliers/vendors, or enterprise resource planning (ERP) groups.

In some aspects, the inspection system may determine inspection recipes that instruct image capture devices. The instructions may be automatic, manual, or a combination thereof. The inspection system may also validate and analyze the images and determine further MRO tasks based on the image validation and analysis. The inspection system may generate reports that incorporate the inspection data and initiate logistics tasks, MRO instructions, or reporting based on the inspection data. Currently, non-standard inspection processes cause inspections to vary across service locations and product lines which further leads to non-standard customer output documentation. In some embodiments, the systems and methods disclosed herein provide an inspection software application that provides standardization and guidance of the component inspection process. In some embodiments, the systems and methods disclosed herein may also be used for outbound inspection on a component that had completed MRO. In some embodiments, the software application includes Artificial Intelligence (AI) assisted disposition determination. In some embodiments. the systems and methods disclosed herein may also increase the inspection quality of borescope inspections and reduce the skill requirement of the inspection operator.

In some embodiments, the systems and methods disclosed herein use defined templates and guided overlays to standardize the capture of engine externals. Customizable templates can be shared between shops to standardize inspection across the network. In-template part disposition determination further reduces errors in part check-in. In some embodiments, the system provides a data pipeline to allow data to be uploaded and processed through to relevant shop tools, avoiding additional manual data entry. The system may further provide automated notifications to downstream users (e.g., quality and engineering). In some embodiments, at the point of inspection, time-sensitive notifications can be generated alerting customers, quality teams, and/or engineering teams of issues as early as possible. In some embodiments, post-inspection reporting may be provided to assist in customer discussions and increase confidence in the reported status. In some embodiments, the system further provides fully searchable meta-data in the images to increase efficiency in component data searches.

In some embodiments, an inspection system may leverage AI and robotics to improve image consistency between inspections and enable application of predictive workscopes. In some embodiments, the process can reduce turn time and prevent engine re-induction (e.g., returned for further inspection, serving, or repairs). In some embodiments, the systems and methods disclosed herein reduce labor hours, distance traveled by workers, and enable real-time problem solving.

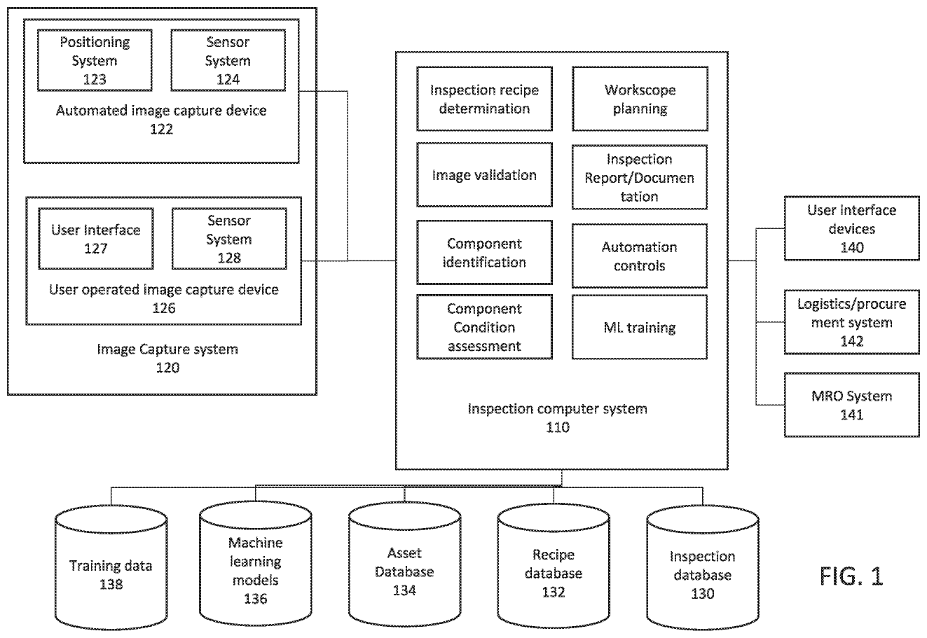

Referring to FIG. 1, an exemplary aircraft component inspection system 100 is shown. In FIG. 1, the inspection system 100 includes an inspection computer system 110 that is communicatively coupled to an image capture system 120, and a plurality of databases 130-138.

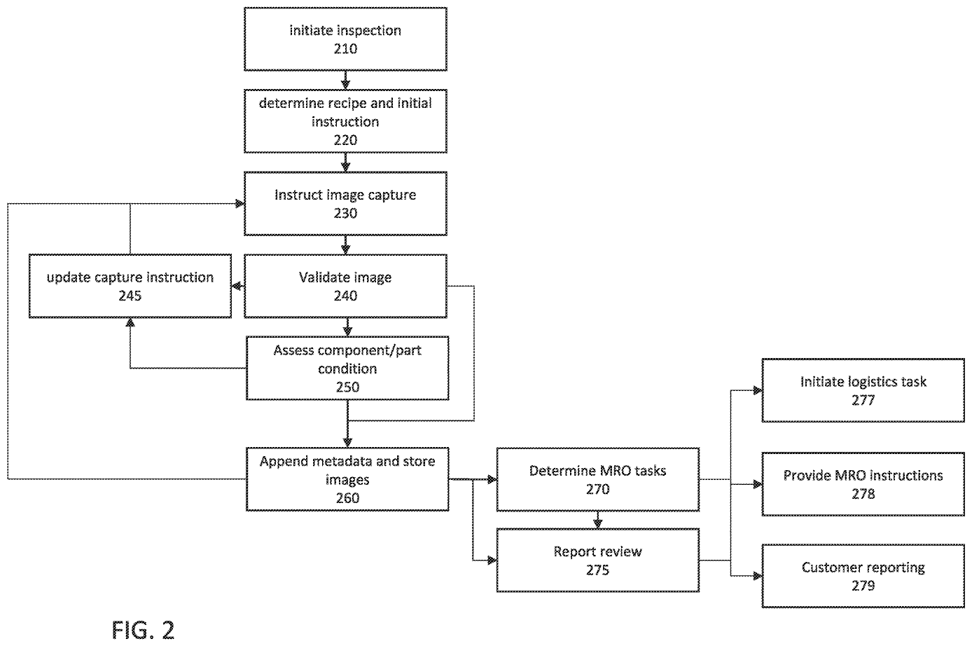

The inspection computer system 110 may comprise a processor-based device comprising one or more processors and memories. The inspection computer system 110 comprises a control circuit, a memory, and a network interface device for communicating with the image capture system 120 and/or the plurality of databases (e.g., databases 130-138). In some embodiments, the inspection computer system 110 may comprise one or more of a control circuit, a microprocessor, a central processing unit (CPU), a graphics processing unit (GPU), an application-specific integrated circuit (ASIC), and the like and may be configured to execute computer-readable instructions stored on a computer-readable storage memory. The computer-readable storage memory may comprise volatile and/or non-volatile memory and have stored upon it computer-readable codes which, when executed by the processor, cause the inspection computer system 110 to perform inspection recipe determination, image validation, component identification, component condition assessment, workscope planning, inspection report and documentation, automation controls, and/or machine learning model training in support of aircraft component inspection operations. Further details of functions that may be executed by the inspection computer system 110 according to some embodiments are described herein, for example, with reference to FIGS. 2-6, 9-10, and 12-14. The inspection computer system 110 may be located locally or remotely from the image capture system 120 and communicate with the image capture system 120 via a wired connection, a wireless local area network connection, and/or over a wide area network. In some embodiments, the inspection computer system 110 may communicate with a plurality of image capture systems 120 in one or more inspection spaces for inspection of one or more aircraft components.

The image capture system 120 may comprise an automated image capture device 122 and/or a user operated image capture device 126. In some embodiments, the image capture system 120 may comprise a plurality of automated image capture devices 122 and/or a plurality of user operated image capture devices 126.

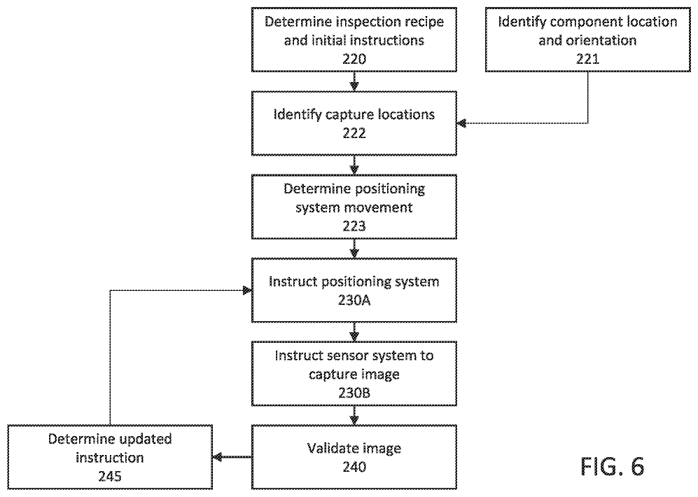

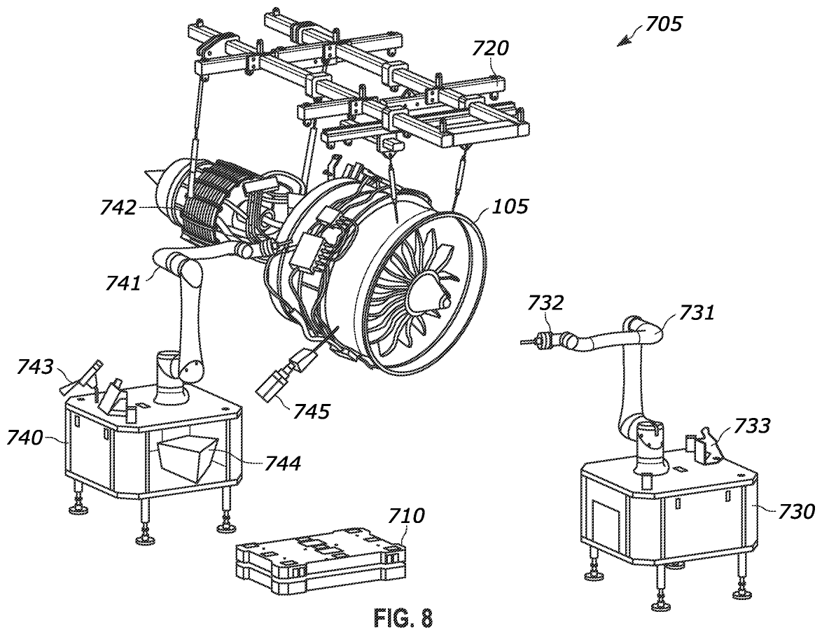

The automated image capture device 122 comprises a positioning system 123 and a sensor system 124. The positioning system 123 generally comprises a mechanical system configured to change the relative positioning of the sensor system 124 and the component or part of the component being inspected. In some embodiments, the positioning system 123 may be physically coupled to one or more sensors of the sensor system 124 to move the sensors around the component. In some embodiments, the positioning system 123 is further configured to control the orientation of the sensors. In some embodiments, the positioning system 123 may be configured to manipulate the orientation of the component or a part of the component to provide different views of the component to the sensor system 124. In some embodiments, the positioning system 123 may comprise a ground or aerial automated guided vehicle (AGV). In some embodiments, the positioning system 123 may comprise a snake arm robot configured to perform borescope inspection of component interiors. Examples of positioning systems that may be used with an inspection computer system 110 according to some embodiments are described herein, for example, with reference to FIG. 6, FIGS, 7A-H, and FIG. 8.

The sensor system 124 comprises one or more image sensors configured to capture images from the component being inspected. In some embodiments, the sensor system 124 may comprise a plurality of sensors of different sensor types (e.g., an optical sensor, a three-dimensional (3D) scanner, a stereo camera, an infrared sensor, a terahertz spectroscope, a microwave imaging sensor, an x-ray imager, a computed-tomography scanner, an eddy current imaging sensor, an ultrasound imager, etc.). In some embodiments, the sensor system may comprise a sensor array with multiple sensors with varying focal lengths and/or orientations. In some embodiments, the inspection computer system 110 may be communicatively coupled to other types of sensors such as gas sensors, acoustic sensors, thermal sensors, etc. Further examples of sensor systems that may be used with an inspection computer system 110 according to some embodiments are described herein, for example, with reference to FIG. 6 and FIG. 8.

As shown in FIG. 1, the user operated image capture device 126 comprises a user interface 127 and a sensor system 128. In some embodiments, the user interface 127 is configured to enable a user to capture images and adjust image capture settings. The user interface 127 may include one or more buttons, sliders, etc., for adjusting image capture settings. The sensor system 128 comprises one or more image sensors configured to capture images from the component being inspected. In some embodiments, the sensor system 124 may comprise a plurality of sensors of different sensor types (e.g. an optical sensor, a 3D scanner, a stereo camera, an infrared sensor, a terahertz spectroscope, a microwave imaging sensor, an x-ray imager, a computed-tomography scanner, an eddy current imaging sensor, an ultrasound imager, etc.). In some embodiments, the sensor system may comprise a sensor array with multiple sensors with varying focal lengths and/or orientations.

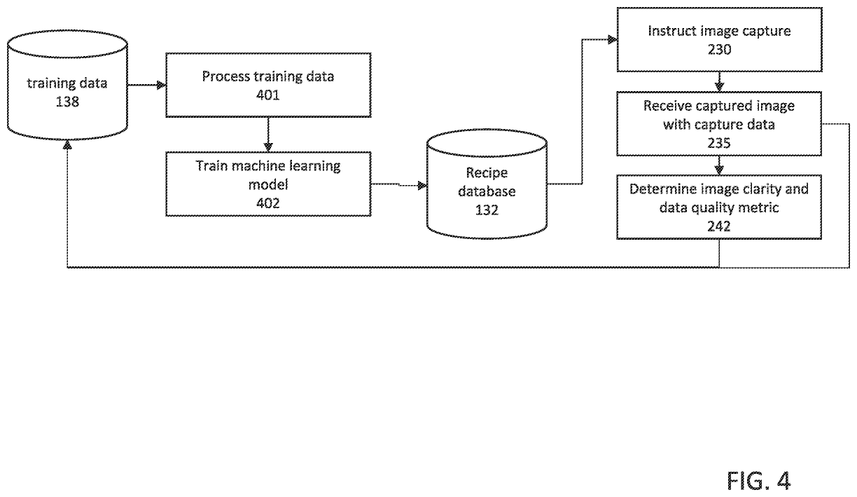

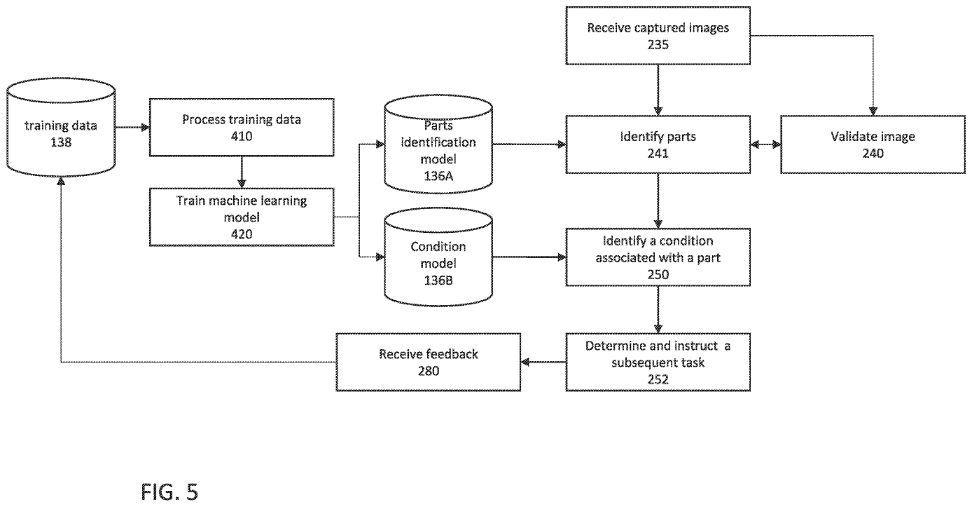

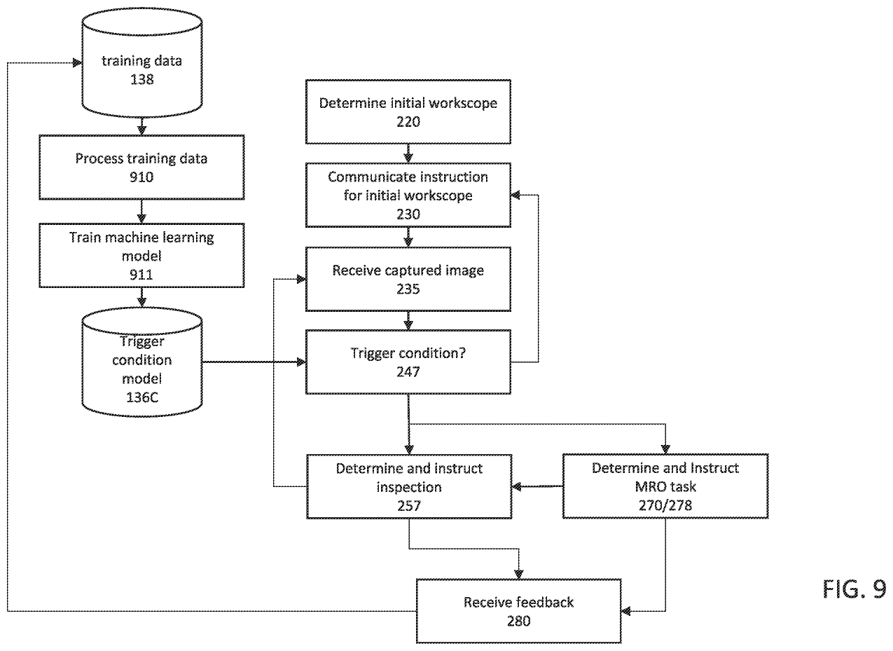

The inspection computer system 110 may be coupled to a plurality of local, remote, and/or cloud databases to retrieve data for performing various functions described herein and/or to store generated data. In some embodiments, data stored in the databases may include training data 138, machine learning models 136, asset database 134, recipe database 132, and inspection database 130. Training data 138 may be used to train one or more machine learning models 136 used by the inspection computer system 110. In some embodiments, machine learning models 136 may include a recipe machine learning model described with reference to FIG. 4, a part identification model 136A and a condition model 136B described with reference to FIG. 5, and/or a trigger condition model 136C described with reference to FIG. 9. Further descriptions of the training and the use of machine learning models according to some embodiments are provided herein, for example, with reference to these figures.

The asset database 134 stores asset data such as data on a plurality of aircraft components and/or component parts. As used herein, asset may refer to any aircraft component such as engine and engine component. In some embodiments, the asset database 134 may store asset tracking data, associating component/part identifiers with component/part description and sales information. In some embodiments, the asset database 134 may further store other context/historical information such as installation data, customer information, manufacturing date, service and inspection history, usage information, context information, etc. Information stored in the asset database 134 may be used by the inspection computer system 110 to configure inspection recipes, inspection tasks, MRO tasks, etc. In some embodiments, the information stored in the asset database 134 may further be used for inspection reporting and documentation.

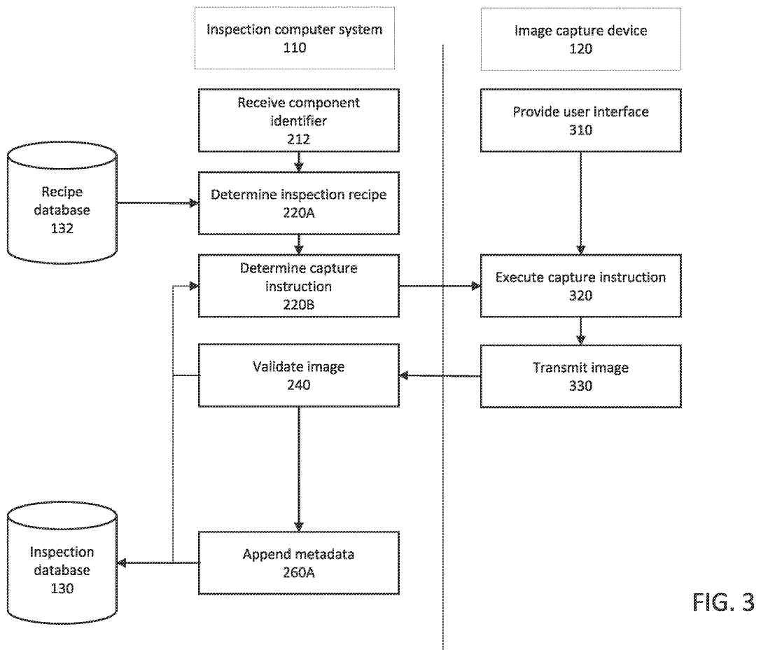

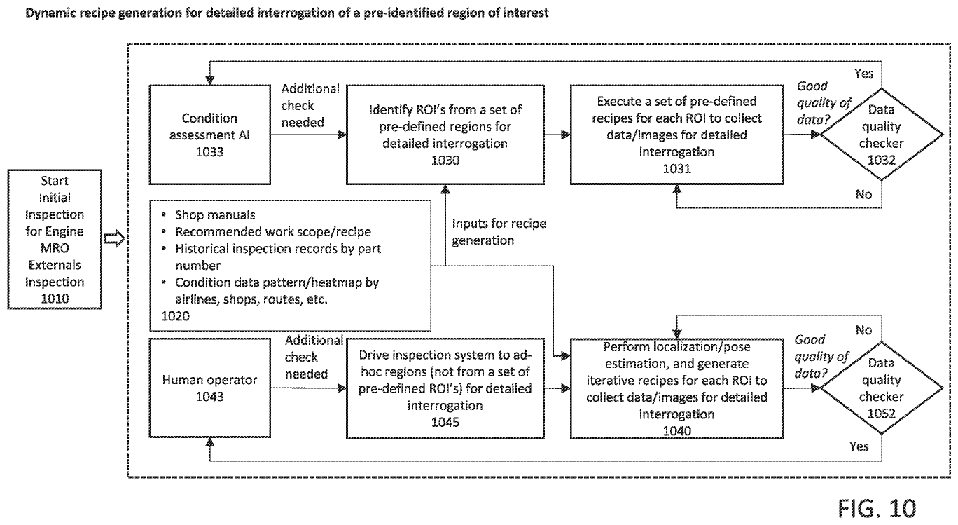

The recipe database 132 stores inspection recipes to be executed by the inspection computer system 110. In some embodiments, the recipe database 132 may store a plurality of recipes each associated with a different aircraft component and/or component model/product line. In some embodiments, a recipe may specify a required data set to be captured during an inspection task of a component. In some embodiments, the data set may comprise required images that may specify capture locations and/or capture configurations. In some embodiments, the recipe may further specify component parts that should be captured in each required image. In some embodiments, a recipe may require an order for the images to be captured. In some embodiments, a recipe may further include requirements for the overall inspection task. For example, the recipe may require that the captured images collectively cover at least a percentage (e.g. 99%, 90%) of the surface of the component. Further details of inspection recipes are described herein, for example, with reference to FIGS. 3 and 4. In some embodiments, one or more recipes may be an adaptive recipe that is used in response to a trigger condition being detected. Further details of adaptive inspection are described herein, for example, with reference to FIGS. 9-10.

The inspection database 130 stores inspection data recorded via the image capture system 120 and the inspection computer system 110. In some embodiments, inspection data of an inspection task may include a plurality of images appended with metadata. In some embodiments, metadata may include one or more of part identifiers, location identifiers, capture configuration identifiers, condition identifiers, etc. Further examples and descriptions of image metadata according to some embodiments are described with reference to FIGS. 3 and 5 herein.

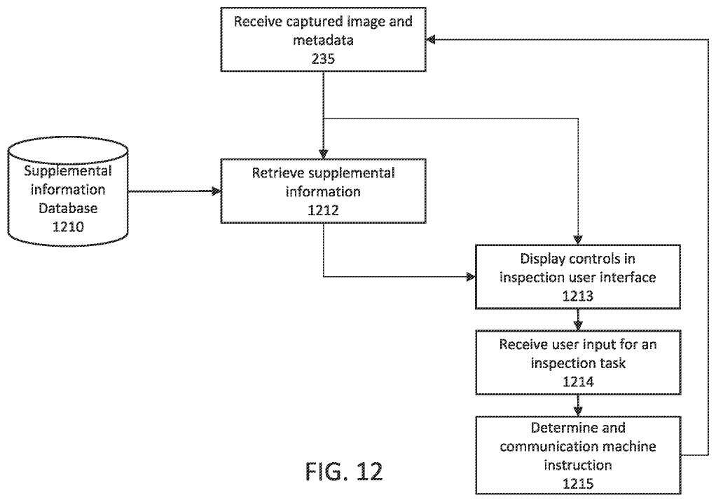

The inspection computer system 110 may further be coupled to a user interface device 140 that functions as a review and control center for inspection. In some embodiments, a graphical user interface (GUI) may be provided on the user interface device 140 for reviewing the captured images and associated data. In some embodiments, the user interface device 140 may further provide a control user interface that can be operated to remotely control one or more devices of the image capture system 120. Further descriptions of inspection review and control systems according to some embodiments are described herein, for example, with reference to FIGS. 12-16.

In some embodiments, the inspection computer system 110 may further be communicatively coupled to other systems based on the inspection data. For example, the inspection computer system 110 may determine MRO tasks and communicate the instructions to the MRO system 141 for execution. The MRO system 141 may comprise user interfaces for displaying MRO tasks and/or automated systems for automatically carrying out MRO tasks in response to receiving the tasks/instruction from the inspection computer system 110. In some embodiments, the MRO system 141 may return MRO data to the inspection computer system 110 to be stored as training data 138 for machine learning model 136 training. In some embodiments, the inspection computer system 110 may further communicate with a logistics/procurement system 142 to initiate the ordering of missing or damaged parts identified during the inspection process.

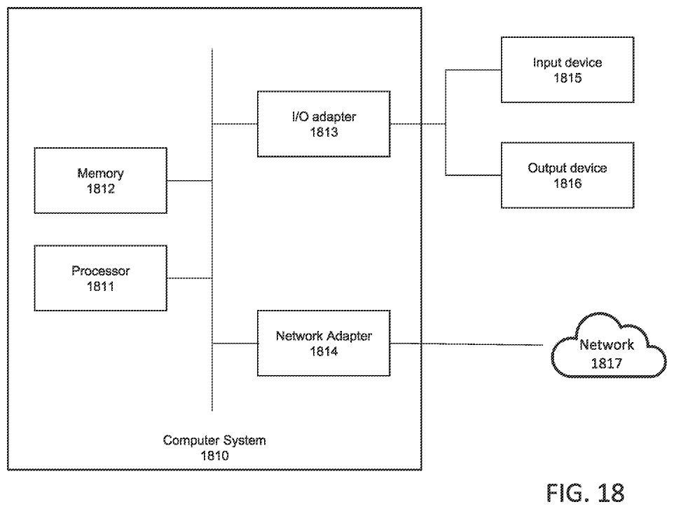

In some embodiments, the inspection computer system 110, the image capture system 120, one or more of the user interface devices 140, the logistics/procurement system 142, and the MRO system 141 are implemented as a computer system 1810 shown in FIG. 18.

In FIG. 18, the computer system 1810 comprises a processor 1811, a memory 1812, an input/output (I/O) adapter 1813, and a network adapter 1814 communicating on a bus. In some embodiments, the computer system 1810 may include other common components of a processor-based device. The processor 1811 is configured to execute computer readable instructions stored on memory 1812 to perform one or more functions described herein. The processor 1811 is further configured to receive and/or transmit data via the I/O adapter 1813 and/or the network adapter 1814. In some embodiments, the input device 1815 and the output device 1816 may comprise user interface devices such as display screens, touch screens, keyboards, microphones, speakers, cameras, motion sensors, etc. In some embodiments, the computer system 1810 may communicate with one or more other devices or databases over a network 1817 via the network adapter 1814. In some embodiments, the network 1817 may comprise a local or wide-area network such as the Internet. While the computer system 1810 is shown with a single processor 1811 and memory 1812, in some embodiments, the computer system 1810 may be implemented on a cloud-based computer having a plurality of distributed processors and memories.

Next referring to FIG. 2, a process for performing aircraft component inspection is shown. The steps in FIG. 2 may be performed by one or more processor-based devices. In some embodiments, one or more steps of FIG. 2 may be performed by the inspection computer system 110, image capture system 120, and/or the user interface device 140 described with reference to FIG. I herein.

In step 210, inspection is initiated. In some embodiments, the inspection may be an initial inspection of an aircraft component at an MRO facility. The inspection task may provide documentation of the initial state of the component prior to MRO processes. In some embodiments, prior to step 210, the component may be cleaned (e.g., via foam washing) to provide better visibility to parts and surfaces of the component. In some embodiments, the aircraft component may be a turbo engine. In some embodiments, the inspection systems and processes described herein may also be used to inspect other aircraft components such as fuselage, wings, landing gears, fuel systems, etc. In some embodiments, a component identifier may be provided in step 210. In some embodiments, the component identifier may be entered by a user, provided by a task management system, and/or captured with an imaging system.

In step 220, the system determines an inspection recipe for the inspection task and determines the initial instruction. In step 230, the system instructs an image capture system (e.g., the image capture system 120 of FIG. 1) based on the initial instructions. Further details of the inspection recipe and initial instruction determination according to some embodiments are described herein, for example, with reference to FIGS. 3, 4, and 6.

In step 240, the system validates the captured image received from the image capture system. If the image does not pass validation, the system may update the capture instruction in step 245 to cause a new image to be captured. In step 250, the system further assesses the condition of the component and/or a part of the component based on the captured images. If a trigger condition is detected, the system may cause additional images to be captured by updating the capture instruction in step 245. Further details of image validation and condition assessment according to some embodiments are described herein, for example, with reference to FIGS. 3-6, 9-10, and 12.

In step 260, the system appends metadata and stores the captured images in an inspection database 130. In some embodiments, metadata may comprise an image capture system location, an image capture system orientation, an image capture system identifier, an imaged component location, a component identifier, and/or a time stamp. In some embodiments, the inspection recipe associates the required image with a component part identifier, and the metadata comprises the component part identifier from the inspection recipe. In some embodiments, metadata comprises a component part identifier determined based on machine object detection, machine feature detection, an object recognition algorithm, and/or an optical character recognition algorithm. Further details of image metadata and component part identification are described herein, for example, with reference to FIG. 1 and 3-6.

In step 270, the system may determine MRO tasks based on the inspection result. In step 275, the system may provide a user interface for reviewing the inspection result. The output of the inspection may be used to initiate logistics tasks in step 277, provide MRO instructions in step 278, and/or generate reports for internal or customer use in step 279. Further details of inspection review, control user interfaces, and inspection reporting are described herein, for example, with reference to FIGS. 12-16.

In some embodiments, the system and methods described herein may provide whole engine inspection guidance and data capture. The inspection systems and methods may include documenting the condition of an entire assembled engine when the engine is received for service and when the engine is released back to the customer. This documentation helps in refining the necessary work scope for the service visit, helps in verifying the completion of the work scope, and serves as a reference in any disputes on the condition of the engine. In some approaches, the inspection systems and methods may utilize photographic view recipes—from experts, manuals, simulation (such as Computer-Aided-Design(CAD)), etc. In some approaches, the inspection systems and methods may involve guidance to acquire photographs in a recipe for engine inspection. In other approaches, the inspection systems and methods may involve verifying that photographs match the recipe. In yet other approaches, the inspection systems and methods may involve verifying that photographs provide complete or adequate coverage (3D) of the engine. In other approaches, the inspection systems and methods may involve automated tagging of images with photograph content for downstream processes.

Documenting the condition of a whole engine involves collecting a set of photographs that completely or adequately cover the external and internal components of the engine with sufficient detail (e.g., sufficient magnification, perspective, and resolution) to define repair work scope and verify workscope completion. A challenge in collecting these photographs is ensuring the photographs cover the entire engine and are of high quality. For example, it may be useful to ensure photographs are taken from view perspectives that present key components and surfaces in sufficient resolution and with detail and lighting to allow for interpretation for work scope definition and verification. There may be additional challenges in establishing photograph completeness for missing engine components or components with substantial damage.

The inspection systems and methods described herein may guide the collection of whole engine external and internal photographs by: (1) directly leveraging or learning from expert knowledge and simulation (CAD) to define camera positions which will capture key components and surfaces from proper perspectives and with sufficient resolution; (2) guiding a user (e.g., via augmented reality) or automated system to capture these images in sequence through reference images, visual overlays, and positioning prompts (e.g., pan up/down, left/right, in/out; rotate by adjusting pitch, yaw, roll); and (3) verifying complete or adequate coverage through image comparisons or evaluating the completeness of a 3D reconstruction. Further, inspection systems and methods described herein may tag images with each specific engine component or surface information (e.g., geo-tagging the images) for downstream consumption.

The inspection systems and methods may directly leverage experts to define recipes to capture a high-quality and complete set of photographs. In addition, the inspection systems and methods may indirectly leverage maintenance manuals (e.g., using AI) to define a portion of the component and surface views called out by figures in the manuals. The inspection systems and methods may also indirectly leverage experts to learn, using AI, how experts capture high-quality and complete sets of photographs. The inspection systems and methods may also directly leverage CAD (e.g., via a product view) information and camera simulation using AI to define a minimal set of views that meet the component and surface requirements and completeness. The inspection systems and methods may also guide the collection of photographs through reference images, through on-screen overlays, and/or through on-screen navigation and positioning prompts (e.g., pan left/right, up/down, in/out; rotate pitch, yaw, roll). The inspection systems and methods may further guide the collection of images by projecting (e.g., via a laser) targets onto the components.

In some approaches, the inspection systems and methods may verify the completeness of the set of photographs via image comparison to a reference set using AI. The inspection systems and methods may also verify the completeness of the set of photographs via 3D reconstruction and identify where the reconstruction differs from the expected reconstruction.

In some approaches, the inspection systems and methods may also directly tag images with target content information such as an engine serial number (ESN), date/time, components imaged, serial numbers, or other information. The systems and methods may also indirectly tag images with information such as ESN, date/time, components imaged, serial numbers, etc., using object detectors (e.g., via AI), feature detectors (e.g., via AI), and OCR (e.g., via AI).

Next referring to FIG. 3, a method for inspection guidance is provided. The method may be carried out based on communications between an inspection computer system 110 and an image capture system 120. In some embodiments, the image capture system 120 may be a user operated image capture device 126 operated by an inspection operator in an inspection area near the aircraft component being inspected (such as an engine). In some embodiments, the image capture system 120 may comprise an automated image capture device 122 including one or more image sensors and one or more automated positioning devices. The inspection computer system 110 may be located within or near the inspection area, at a remote location, or in the cloud network. In some embodiments, the inspection computer system 110 may be implemented as a plurality of physically separated processor-based devices. In some embodiments, the inspection computer system 110 may communicate inspection instructions to a plurality of image capture devices such as a plurality of automated image capture devices 122 having different sensor types and/or a combination of automated image capture devices 122 and user operated image capture devices 126.

In step 212, the system receives a component identifier. In some embodiments, the component identifier may be inputted via the user interface device, received from an asset or task management system, and/or captured by an image capture device (e.g., the image capture system 120 of FIG. 1). In some embodiments, the component identifier may comprise a component/engine serial number, model identifier, product line identifier, etc.

In step 220A, the inspection computer system 110 determines an inspection recipe. In some embodiments, the inspection recipe is retrieved from a recipe database 132 based on the identifier associated with the component. In some embodiments, the inspection recipe is generated based on a recipe machine learning model trained on a plurality of sets of images captured from a plurality of components, physical component models, and/or computer component models. The images in the training set may be tagged with image quality metrics identifying image clarity and data qualities of the images. The images in the training set may include capture information such as capture location, capture orientation, sensor configuration, etc., that are used as training data for the machine learning model. The recipe machine learning model may be configured to determine capture locations, orientations, and/or sensor configurations to increase/maximize the image quality metrics for an inspection. Further details of the machine learning algorithm generated recipes are described with reference to FIG. 4. In some embodiments, the inspection recipe is generated based on mapping, with a computer-vision algorithm, reference images in a maintenance manual associated with the component with a computer model of the component. In some embodiments, the inspection recipe is generated based on simulating camera views on a computer model of the component to define a minimal set of views that cover predefined portions of the component.

In some embodiments, prior to step 220A, the inspection computer system 110 further retrieves component context data such as component inspection history, a component repair history, a customer-specified mission requirement, an identified issue, component use history (e.g. flight path heatmap), and/or geographic region of the component being inspected or components of the same make, model, customer, and usage history. In some embodiments, the inspection recipe is further determined based on the context data. For example, additional or modified required images and/or capture locations may be added to the recipe for components with specific usage history or geographic region. In a specific example, an engine used by an airline with a route having a flight path heatmap concentrated in desert areas, the recipe may include additional required images of areas of the engine that are particularly susceptible to sand accumulation and abrasion damages. In some embodiments, the context data may be retrieved from an asset database 134 storing customer information, usage history, and repair history of various components of an engine or aircraft. In some embodiments, the context data may also be included in the training data set for training the recipe machine learning model.

In some embodiments, the inspection recipe identifies a plurality of required images to be captured during an inspection workscope. In some embodiments, the inspection recipe specifies an instructed image capture location associated with the required image, wherein the instructed capture location includes a coordinate location relative to an inspection space, the component, or a part of a component. In some embodiments, the inspection recipe specifies an instructed image capture location associated with the required image, wherein the instructed capture location includes a distance from the part of the component. In some embodiments, the inspection recipe specifies an instructed image capture orientation, comprising roll, pitch, and/or yaw of a sensor of the image capture system. In some embodiments, the inspection recipe specifies a view of the component for the required image, wherein the view of the component defines the size and/or orientation of a portion of the component within an image frame. In some embodiments, the inspection recipe specifies image type and/or an image capture system type for the required image. In some embodiments, the image capture system comprises a plurality of types of sensors, such as an optical sensor, an infrared sensor, a terahertz spectroscope, a microwave imaging sensor, an x-ray imager, a computed-tomography scanner, an eddy current imaging sensor, or an ultrasound imager.

In step 220B, the inspection computer system 110 determines captured instructions for the user interface based on the recipe. In some embodiments, the inspection computer system 110 may determine instructions for each required image in the recipe. In some embodiments, the instruction may comprise one or more of a capture location, capture angle, and capture configuration.

In step 310, an inspection user interface is provided on the image capture system 120. In some embodiments, the inspection user interface may comprise a graphical user interface of an application executed on a mobile device such as a tablet computer, a head-mounted display device, and/or an AR or VR device. In some embodiments, step 310 may be omitted for automated image capture device 122. In some embodiments, for the automated image capture device 122 review and control user interface may be displayed on a user interface device while the captures are being performed. An operator of the review and control user interface may review images captured by the automated image capture device 122 and adjust capture location, capture configuration, and/or capture timing for additional/subsequent captures.

In step 320, capture instruction is executed on the user interface. In some embodiments, the instruction comprises machine instruction for controlling a movement of a positioning system of the automated image capture device 122. In some embodiments, the machine instructions may comprise positioning instructions for a positioning system 123 and capture configuration and timing information for a sensor system 124.

In some embodiments, the capture instruction is executed by displaying the instruction on a user interface display of the user operated image capture device 126. In some embodiments, instruction comprises an augmented or mixed reality display displayed on the image capture system 120 that overlays the instruction over a view of a portion of the component. In some embodiments, the instruction displayed on the user interface device comprises a reference image of a portion of the component to be captured, an outline of a portion of the component to be captured, and/or an image of the component with an identifier marking a location of the portion of the component to be captured. In some embodiments, the system comprises a projection display device and instructions from the instruction set are projected onto surfaces of the component being inspected and/or around the component being inspected.

In some embodiments, the inspection computer system 110 and/or the image capture system 120 is configured to identify an image capture system location relative to the component based on a location sensor on the image capture system, an image captured by the image capture system 120, or an image captured by a separate sensor system, and provide capture instructions to the image capture system 120 based on the image capture system location. In some embodiments, the inspection computer system 110 and/or the image capture system 120 is further configured to determine an image capture system orientation relative to the component, and the capture instructions are further provided based on the image capture system orientation.

In some embodiments, the instruction transmitted from inspection computer system 110 to the image capture system 120 is configured to automatically set an image capture configuration on the image capture system, wherein the image capture configuration includes zoom level, exposure time, light sensitivity setting, illumination setting, image resolution, video length, and/or sensor type selection. For example, the instruction may be configured to change the setting of a mobile device camera via the camera API. In some embodiments, the instruction may be configured to change the setting of a sensor device of an automated positioning system. In some embodiments, in response to displaying of capture instruction, image capture is triggered by an operator of a user operated image capture device 126 via a graphical user interface. In some embodiments, the inspection computer system 110 and/or the image capture system 120 may automatically trigger the capture when the sensor and/or user device is detected to be at the capture location and/or orientation. In some embodiments, the image capture system 120 can continuously record images and the inspection computer system 110 and/or the image capture system 120 may selectively transmit and/or store the frames/images that match the location and/or quality requirements of the inspection recipe.

In some embodiments, the inspection computer system 110 is further configured to provide instructions to a second image capture system concurrently based on the recipe to capture the required images specified in the recipe. For example, two or more operators and/or automated image capture devices 122 may cooperatively and concurrently capture images during the inspection workscope of a component.

In step 330, the image capture system 120 transmits the captured image to the inspection computer system 110. In some embodiments, the captured image may comprise a still image or a video having a plurality of frames and/or a plurality of channels. In some embodiments, the captured images are transmitted along with metadata identifying capture location and/or capture configuration recorded during the capturing of the image.

In step 240, the inspection computer system 110 validates the image received from the image capture system 120. In some embodiments, the image is validated based on image capture system location and/or image quality. In some embodiments, the images are validated for clarity (e.g. focus blur, motion blur, brightness, sharpness) and for data quality based on the recipe requirement. In some embodiments, the inspection recipe identifies a portion of the component associated with the required image, and the captured image is validated based on detecting for the portion of the component in the captured image based on machine object detection, machine feature detection, an object recognition algorithm, and/or an optical character recognition algorithm. In some embodiments, the inspection recipe identifies a portion of the component associated with the required image, and the captured image is validated based on comparing the captured image with a computer model of the component, a previously captured image from the component, and/or a previously captured image from a similar component associated with the portion of the component. In some embodiments, the inspection recipe identifies a computer model of the component and the captured image is validated based on identifying a gap in coverage by comparing the computer model and the captured image, and the processor is further configured to instruct additional capture tasks based on the gap in coverage. In some embodiments, the inspection computer system 110 is configured to validate the inspection by comparing portions of the component imaged to images captured during the inspection workscope with a completeness requirement specified in the inspection recipe. In some embodiments, the image capture system 120 may be configured to perform some or all of the image validations described with reference to step 240.

If an image does not pass validation, the system returns to step 220B. For a user operated image capture device 126 the operator may be instructed to recapture the image. In some embodiments, the user instruction to recapture may include a capture suggestion (e.g., move closer to the area of interest, increase lighting, hold still, clean lens, etc.). In some embodiments, the capture suggestion may be determined based on the image issue identified in step 240. For an automated image capture device 122, the inspection computer system 110 may determine a modified machine capture instruction in step 220B. In some embodiments, the modified capture instruction may be determined based on a predetermined detail integration recipe, a predetermined varied capture recipe, and/or by analyzing the captured image. Further details of the adapted image capture are described with reference to FIGS. 9-10 herein. The image capture system 120 may capture a new image based on the recapture instruction and the new image may be validated again at step 240. In some embodiments, steps 220B, 320, 330, and 240 may be repeated until an image that meets the requirements of the inspection recipe is captured. In some embodiments, the inspection recipe may comprise overall inspection task requirements, such as overall coverage, completeness, and the amount of overlap between one or more images. The captured images may be collectively validated against the overall requirements prior to the completion of the inspection task.

If an image passes validation, in step 260A, the inspection computer system 110 appends metadata to the image for storage in an inspection database 130. In some embodiments, the metadata comprises capture metadata recorded by the image capture system 120. In some embodiments, metadata may include an image capture system location, an image capture system orientation, an image capture system identifier, an imaged component location, a component identifier, and/or a time stamp. In some embodiments, the inspection recipe associates the required image with a component part identifier, and the metadata comprises the component part identifier from the inspection recipe. In some embodiments, metadata comprises a component part identifier determined based on machine object detection, machine feature detection, an object recognition algorithm, and/or an optical character recognition algorithm. Further details of component part identification are described herein, for example, with reference to FIG. 5 herein. In some embodiments, the image metadata may comprise capture configurations such as zoom level, focal length, exposure time, light sensitivity setting, illumination setting, image resolution, video length, and/or sensor type selection. In some embodiments, the inspection computer system 110 may superimpose at least part of the metadata (e.g., part name, component identifier, capture data) over the captured image.

In some embodiments, the inspection computer system 110 may further be configured to identify an anomaly based on data recorded by the image capture system. In some embodiments, the anomaly may be appended as metadata. In some embodiments, the inspection computer system 110 may modify instructions communicated to the image capture system 120 based on the anomaly prior to the completion of the inspection workscope. In some embodiments, the inspection computer system 110 may further determine a workscope of a repair or maintenance task based on a plurality of images captured by the image capture system 120 in response to receiving instructions from the processor.

Next referring to FIG. 4, an example process for generating an inspection recipe via machine learning is shown. In some embodiments, the steps in FIG. 4 may be performed by the inspection computer system 110 and/or a separate machine learning computer system.

In step 230, the system instructs image capture via an image capture system 120. In step 235, the system receives captured images with capture data. In some embodiments, capture data may comprise capture location and capture configuration. In step 242, the system may determine an image clarity metric and data quality metric. In some embodiments, step 242 may be automated by the system with an image analysis algorithm, object detection algorithm, etc. In some embodiments, step 242 may comprise a score inputted by a reviewer. The image capture data and metrics are stored as training data 138. In some embodiments, the images are also included in the training data 138. In some embodiments, images may be tagged with other data such as component identifier, part identifier, component context data, and/or shop data. In step 401, the system processes the training data to filter and organize information relevant to recipe machine learning model training. In step 402, a recipe model is trained/retrained with the training data 138. In some embodiments, the machine learning model may be trained with a plurality of images tagged with capture locations, capture configurations, and image metrics to select a set of capture locations to optimize image metrics for the recipes. In some embodiments, the machine learning algorithm described herein may be a supervised, unsupervised, or reinforcement machine learning algorithm. In some embodiments, the machine learning algorithm may include a decision tree, linear regression, neural network, descriptive model, Q-learning, deep adversarial network, and/or temporal difference algorithm. In some embodiments, the plurality of images may be tagged with other data from the training data 138, including context data, and the recipe machine learning model may generate recipes based on the context data. In some embodiments, the training data may include image data captured at a plurality of shop locations, of a plurality of aircraft components of the same or different type, by a plurality of image capture devices, and by a plurality of operators. In some embodiments, the training data may further comprise images from other sources such as computer model simulation, historical inspection images, and service or operation manual images.

In some embodiments, the recipe database 132 may store machine learning models associated with various aircraft components by type, model number, etc. In some embodiments, the recipes may be further associated with other context data such as customer information, geographic information, MRO history, etc. In some embodiments, the trained recipe model may be stored in the recipe database 132, and component information received to initiate an inspection task is used as an input set of the recipe machine learning model to generate a recipe for the inspection task.

The inspection systems and methods described herein may use robotically controlled and digital instrumented data acquisition to drive consistency and completeness in the collection of data used to assess unit condition that drives the work scope planning process. Portions of the inspection process may reduce incomplete or incorrect condition assessments by digitally planning and guiding the inspection workscope to ensure complete information is collected. The guidance and standardization may eliminate or reduce human factors or fatigue that can contribute to missed indications and incorrect condition assessment. The consistency of the data acquisition may then be leveraged to improve the efficacy of AI-assisted condition assessment and to establish a full digital record of inbound unit condition. Various pieces of the digital record may then be connected to MRO logistics in order to control aspects ranging from work force optimization and equipment utilization to inventory management and customer turnaround time estimates.

In some embodiments, an inspection method for engine MRO may involve artificial intelligence/machine learning condition assessment. The work scope planning of engine MRO may begin with a unit inspection to assess the condition and determine any recommended and required repairs that will enable the unit to be returned to service or meet specific mission capability requirements. The inspection method may include AI-assisted condition assessment, for example, AI-driven unit and/or part assessment. AI-assisted condition assessment may include determining the presence or absence of components along with digital work scope planning for improved shop utilization and reduced turnaround times.

The presence or absence of a component or accessory may drive the work scope and connect with logistic functions such as equipment scheduling, selection of technician skillsets, and inventory management which may help to estimate and streamline the MRO process. The inspection method leverages AI and/or computer vision (CV) techniques to enable the recognition of these components by position and other attributes, such as color, shape, and geometry, that drive the disassembly requirements of the unit. The attributes may also be used to ensure the unit is returned to the customer with all the proper accessories that were either cataloged with the inbound record or deemed appropriate to swap or replace. The determining of the proper accessories associated with the unit may involve the identification of data plate serial numbers using AI/OCR. The inspection method may also involve connecting to the ERP system. These techniques may also be used to address parts manufacturer approval (PMA) parts and counterfeit identification, allowing non-approved parts to be identified. Component identification and/or condition may also lead to different work scope planning procedures, such as additional borescope inspection (BSI), or may involve the use of additional inspection modalities.

Observations based on unit condition may be interpreted differently depending on the customer or regional context, where mission profile may affect the asset's residual life, value and maintenance procedures. The inspection method utilizes AI to assess condition and establishes a digital record of unit and/or part condition. The digital record may allow for comparison against design and service limits and can quickly convey the evidence required by a customer to understand if a unit will meet mission requirements and/or obtain the necessary repair authorization. The historical record of previous outcomes may serve as further evidence of current unit maintenance justification. This inspection method may also allow the unit and/or part condition (indication type, location, dimensions, aggregation within assembly, etc.), to be combined with life and durability data and customer specific data, such as unit context (geographic routes, cycle data, etc.) to establish rules by which automatic or semi-automatic authorization may be obtained from the customer, while providing the customer with visibility into the repair workstream. The AI driven condition assessment may also be used to assign asset valuation for units coming off of a lease or being sold for redeployment or scrap.

Next referring to FIG. 5, a process for condition assessment with an inspection system is shown. In some embodiments, one or more steps in FIG. 5 may be performed by a processor-based device such as the inspection computer system 110. In step 235, the system receives captured image(s). In some embodiments, the images may be received in response to instructing image capture in step 230 described with reference to FIG. 2. In some embodiments, the images may be captured by an automated image capture device 122 and/or user operated image capture device 126. While image data is generally described herein, in some embodiments, the condition assessment described in FIG. 5 may further be based on other types of data such as gas emission data, acoustic data, electric signals, airflow measurements, torque measurements, etc.

In step 241, the system identifies one or more parts of the component based on one or more images received in step 235. In some embodiments, component parts are identified using a part identification model 136A. In some embodiments, parts are identified based on identifying data plates (e.g. serial number plate, model identifier plate) associated with the plurality of parts in one or more of the captured images. In some embodiments, parts are identified based on an optical character recognition algorithm performed on one or more of the captured images to identify identifiers (serial number, part number, model number, etc.). In some embodiments, parts are identified based on part shape, color, and/or on-component location appearing in one or more of the captured images. In some embodiments, the parts are identified using a part identification machine learning model and/or a computer vision algorithm. In some embodiments, the parts may be identified based on comparing captured images with reference images of parts of the component. The reference images may be photographs, 3D models, and/or service/operation manual images. In some embodiments, the parts may be identified based at least in part on the location of the image sensor relative to the component. For example, the system may identify a part of the component in an image based on parts that are expected to be within the field of view of the sensor at the sensor location. In some embodiments, the system may simulate the location of the sensor with a 3D model of the component to determine parts that may be within the field of view of the sensor.

In some embodiments, the system further validates the received image in step 240. In some embodiments, the image is validated for clarity (e.g. blurriness, brightness, focus, sharpness) prior to step 241. In some embodiments, the parts identified in step 241 may be used to validate the data quality of the image. For example, the system may determine whether the image covers the area of the component specified by the recipe based on part identification in step 241. In some embodiments, if the image fails validation, recapturing may be instructed as described in, for example, FIGS. 2-3. In one example, for an aircraft engine, parts that may be identified may comprise casing surfaces, mounts, switches, valves, connectors, seals, liners, wires, tubes, fasteners, spacers, ports, turbine, blades, vanes, airfoils, shafts, etc.

In step 250, the system identifies a condition of an identified part based on the captured image. In some embodiments, the condition of the part is determined based on detecting anomalies in the images of the part, which may correspond to wear or damage of the part. In some embodiments, the condition of a part may be determined based on the size, shape, color, 3D profile, and/or location of the anomaly. In some embodiments, the condition may be determined based on other types of data, such as gas emission data, acoustic data, electric signals, airflow measurements, torque measurements, etc. In some embodiments, the condition of a part is identified using a part identification model 136A. In some embodiments, the condition of a part comprises the presence or absence of the part, serviceability of the part, mission capability of the part, and/or maintenance or repair tasks of the part. In some embodiments, the system may compare parts with records in an asset database to determine authenticities, manufacturers, or origins of the plurality of parts. In some embodiments, the system further compares the parts with a set of manufacturing standards to determine standard compliance of the plurality of parts. For example, the system may determine whether an aftermarket part meets the original equipment manufacturer (OEM) standard. In some embodiments, the system may compare conditions of one or more parts with a mission requirement profile to determine a mission suitability matric of the part. In some embodiments, the system further compares the conditions of one or more parts with market value reference data to determine a market value of the component or one or more parts of the component. In some embodiments, in response to the condition of the part being absent or unserviceable, the system may be configured to forward a procurement request to a logistics system to initiate procurement of the missing or damaged part.

In step 252, the system determines and instructs a subsequent task. In some embodiments, the subsequent task comprises a further inspection task, a repair task, or a maintenance task. In some embodiments, the subsequent task may comprise a detail inspection task instructed to the image capture system 120 for additional images to be taken, and steps 235, 240, 241, and 250 may be repeated for the additional images. In some embodiments, the subsequent task may be an adapted inspection task or an MRO task described with reference to FIG. 9.

In step 280, the system receives feedback on the part identification, condition identification, and/or subsequent task determination. In some embodiments, the feedback may be provided by a reviewer. In some embodiments, the feedback may comprise the success or failure of the previous inspection or MRO task. In some embodiments, the part identification, the condition identification, the subsequent task, and/or the feedback may be stored as training data for training the part identification model 136A and/or the condition model 136B. In some embodiments, the training data 138 may comprise a plurality of images of parts tagged with part identifiers. In some embodiments, the part identification model 136A may be trained with a plurality of images of component parts and part identifiers associated with each of the component parts. In some embodiments, the images in the training data set may comprise photographs, 3D component models, and/or MRO manual figures. In some embodiments, the part identification model 136A may be used with a machine vision algorithm to output part identifiers based on input images. In some embodiments, the condition model 136B may be trained with a plurality of images of component parts tagged with associated conditions. In some embodiments, the images may further be tagged with context information such as part age, part usage history, part customer history, part flight paths history, part service history, part repair history, etc. In some embodiments, the images may further be tagged with other associated sensor data such as gas emission data, thermal profile data, acoustics data, etc. The condition model 136B may be trained to receive one or more images of a part captured in step 235, and optionally other context and sensor data, and output a condition associated with the part. In some embodiments, the feedback received in step 280 may be used to select and/or filter out data from the training data 138 and/or place weighting factors on the data in the training data set.

In some embodiments, in step 410, the system processes the training data to filter and organize information relevant to part identification and condition assessment model training. In step 420, the part identification model 136A and/or the condition model 136B are trained/retrained with the training data 138. The system is configured to process/filter the data in the training data 138 based on the model being trained and execute a machine learning algorithm to build and update part identification model 136A and condition model 136B. In some embodiments, the part identification model 136A and the condition model 136B may be combined into a single model. For example, the combined model may be trained with images tagged with both part identifiers and a condition identifier. In some embodiments, the combined model may also be trained with images tagged with context data and other sensor data.

The inspection systems and methods described herein may also incorporate imaging devices and control. The inspection systems and methods may include preconfigured sensors to document the status of externals parts/surfaces of the engine. The inspection systems and methods may also integrate multimodal sensors to configure imaging devices for auto parameter setup for improved inspection quality. In addition, the inspection systems and methods may also use AI assisted multi-sensor enabled inspection to re-configure sensors, detect & identify engine configurations, identify anomalies, and digitize a complete inspection. Further, the inspection systems and methods may also use AI assisted quality assurance in real time to ensure records are of suitable quality before the asset moves on. AI assisted quality assurance may address imaging errors that may occur, for example, due to lighting, movement, focus, etc.

The imaging devices and controls may facilitate consistent positioning systems which may: 1) be preconfigured for sensors to document the status of the engine based on the nominal CAD configuration; 2) integrate multimodal sensors to configure imaging devices for setting up focus, depth of focus and zoom-in/out operations to obtain optimal image quality; and/or 3) leverage AI for identifying features on the engine externals for image quality enhancement and sensor re-configuration. An inspection system that integrates such imaging devices and controls may help to standardize externals inspection of an engine into an AI-assisted multi-sensor enabled inspection to identify anomalies, configure sensors, detect, and identify engine configurations, digitizing a complete inspection for customer interactions and future reference. With this approach, the engine shop visit can be tracked across the globe during MRO shops visits and leverage that data in generating analytics that help understand customer usage.

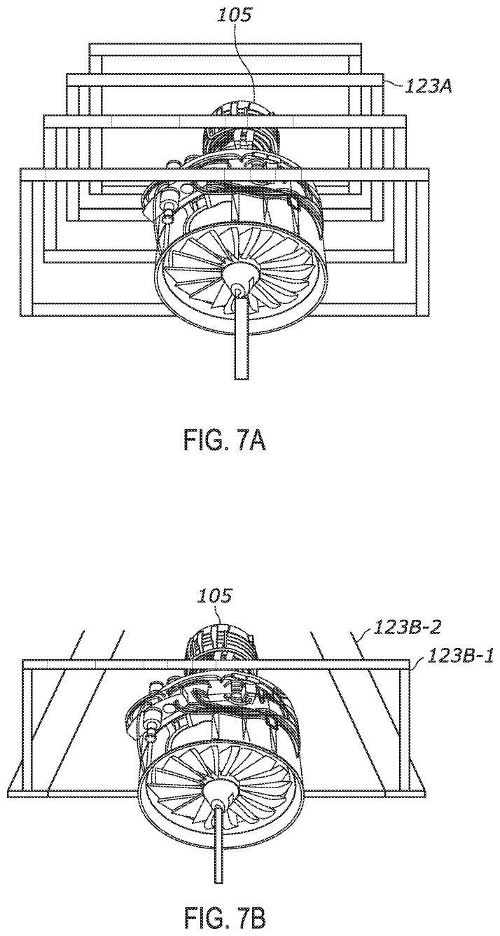

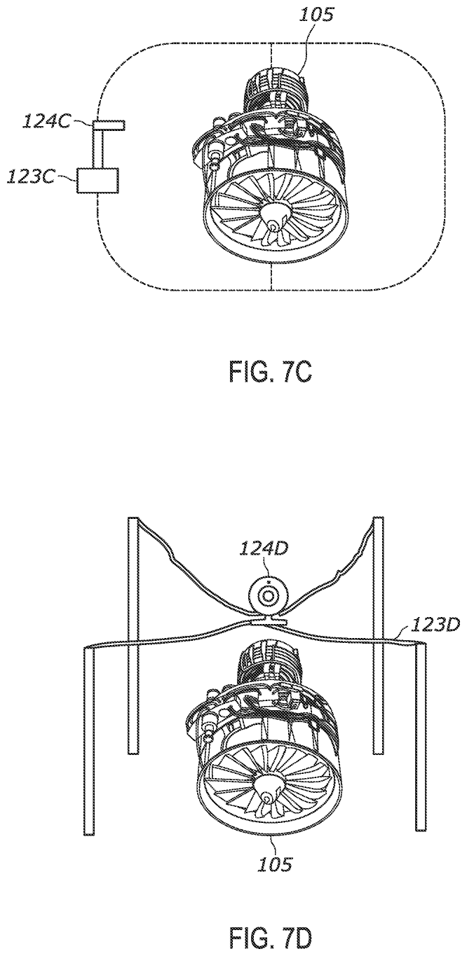

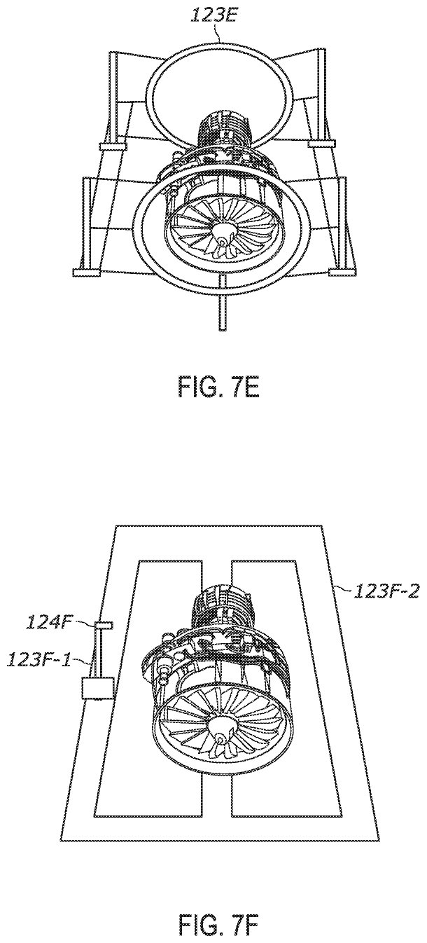

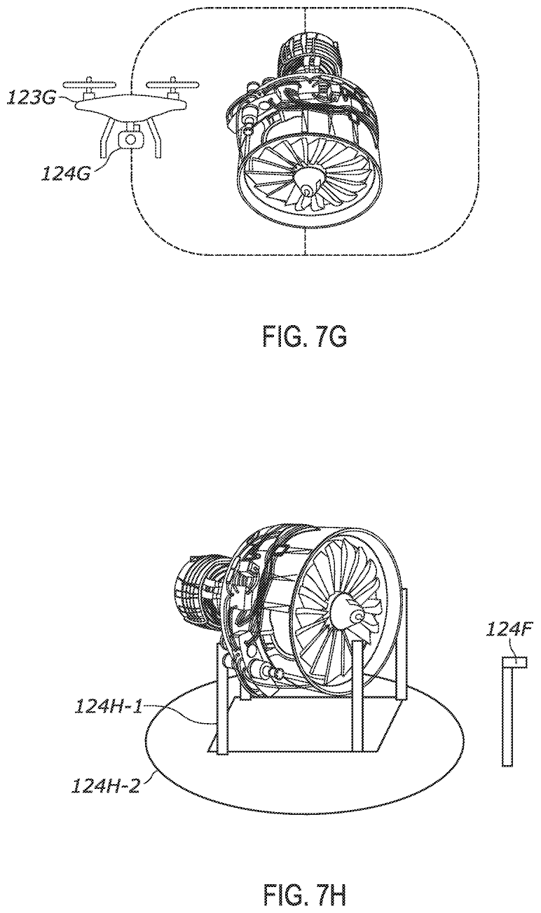

The inspection systems and methods may ensure consistent or improved sensor positioning using one or more of the equipment configurations illustrated in FIGS. 7A-7H and FIG. 8. The inspection system may include a gantry or bay with multiple preprogrammed sensors. The inspection system may also include a gantry moveable by rails with multiple preprogrammed sensors. The inspection system may also include a multi-sensor gantry on rails that is preprogrammed. In another approach, the inspection system may include a bot on rails with single or multiple preprogrammed sensors. In another approach, the inspection system may include a bot with single or multiple preprogrammed sensors. In other approaches, the inspection system may include a sky bot with preprogramed sensors. In other approaches, the inspection system may include a drone to conduct drone-based inspection. In yet other approaches, the inspection system may include a device to move the engine while the camera is stationary.

Referring now to FIG. 6, a method for automated inspection is provided. The automated inspection may be performed on an engine, such as an aircraft engine, or a component thereof. The method may be carried out based on communications between the inspection computer system 110 and the image capture system 120.

In step 220, the inspection computer system 110 determines an inspection recipe and initial instructions for inspection of an engine and/or a component thereof. In some embodiments, the inspection recipe and initial instructions may be determined manually by an inspection operator. For example, an inspection operator may take images. In some embodiments, the inspection recipe and initial instructions are retrieved from the recipe database 132 based on an identifier associated with the engine and/or a component of the engine. The identifier, for example, may be a serial number, a model number, or a classification associated with the engine and/or a component thereof. In some approaches, the inspection computer system 110 may acquire the identifier from an image of the engine and/or a component thereof. For example, the identifier may be acquired from an image of a name plate or, in some aspects, from AI identification of a name plate in an image. In some embodiments, the inspection recipe and initial instructions are retrieved from the recipe database based on an engine or component configuration, for example, as determined based on an electronic drawing file or model such as a CAD file associated with the engine and/or a component thereof.

In yet other embodiments, the inspection recipe and initial instructions are generated based on a recipe machine learning model trained on a plurality of sets of images captured from a plurality of components, physical component models, and/or computer component models. The images in the training set may be tagged with image quality metrics identifying image and data qualities of the images. Further details of the machine learning algorithm generated recipes are described with reference to FIG. 4. In some embodiments, an inspection operator may select the inspection recipe and/or initial instructions for the inspection using the user interface devices 140. In this manner, machine learning may determine recipes and inspection instructions (e.g., image capture locations and settings) that are most likely to yield high quality images.

In other embodiments, the inspection recipe and initial instructions may be determined via simulation on a 3D model such as a CAD model. For example, simulation on a 3D model may be used to determine image capture locations and settings that provide complete or adequate coverage of the engine and/or a component thereof.

The inspection recipe may identify a plurality of locations for performing image capture using the image capture system 120 during an inspection workscope. The plurality of locations may be sensor locations for locating one or more sensors of the image capture system 120 within an imaging space. The inspection recipe may define locations for one or more sensors of the sensor system 124 of the automated image capture device 122 and/or the sensor system 128 of the user operated image capture device 126. Such sensors may comprise one or more of an optical sensor, a LIDAR, a 3D scanner, an infrared sensor, a terahertz spectroscope, a microwave imaging sensor, an x-ray imager, a computed-tomography scanner, an eddy current imaging sensor, or an ultrasound sensor.

The inspection recipe may identify locations for the image capture system 120 relative to an engine, a component, or a part of a component. For example, the locations in the inspection recipe may specify how the automated image capture device 122 or the user operated image capture device 126 should be positioned relative to a component of interest (e.g., the component to be inspected). In one example, the locations are coordinate locations relative to an inspection space, an engine, a component, or a part of a component. The inspection recipe may also specify an image capture orientation such as roll, pitch, and/or yaw for a sensor of the image capture system 120. In some embodiments, the inspection computer system 110 may provide the inspection recipe to the automated image capture device 122. In particular, the inspection computer system 110 may provide the inspection recipe (e.g., capture locations) to the positioning system 123 of the automated image capture device 122.

In other embodiments, the inspection device provides the inspection recipe (e.g., capture locations) to the user operated image capture device 126. The inspection computer system 110 may provide the inspection recipe to the user operated image capture device 126. The user operated image capture device 126 may display the inspection recipe to an inspection operator via the user interface 127. In one example, the user interface 127 may list one or more locations for performing image capture. In another example, the user interface 127 may overlay one or more locations for performing image capture on a 3D model or CAD file of the engine or a component thereof. In this manner, the inspection recipe may guide manual capture of images using the user operated image capture device 126.

The initial instructions may include capture instructions for the automated image capture device 122 and/or for the user operated image capture device 126. The capture instructions may be machine instructions to the positioning system 123 for positioning one or more sensors of the image capture system relative to the engine and/or a component thereof. The capture instructions may also include machine instructions to one or more sensors of the sensor system 124. The machine instructions to the one or more sensors may provide sensor settings or configuration such as image capture configurations. For example, when the sensor is a camera, the instructions may provide image capture configurations such as exposure time, focal length, shutter speed, image resolution, light sensitivity setting, f-number, depth of field, focus, zoom level, contrast-to-noise ratio (CNR), signal-to-noise ratio (SNR), illumination setting, aperture, sensor selection, or other settings. The capture instructions may include machine instructions to one or more sensors of the sensor system 128. The inspection computer system 110 may transmit the machine instructions to the image capture system 120. In some embodiments, the inspection computer system 110 may transmit instructions to the user interface 127 and the user interface 127 may display the instructions to an inspection operator.

In some embodiments, the image capture system 120 may further include an illumination system. The initial instructions may include machine instructions for the illumination system based on the inspection recipe.

In step 221, the inspection computer system 110 may identify the location and/or orientation of the engine and/or a component thereof. The location of the engine and/or component may provide a coordinate location of the engine and/or component relative to an inspection space, an engine, or a component. In this manner, at step 222, the inspection computer system 110 may identify capture locations based on the location and/or orientation of the engine and/or component. For example, the inspection recipe may provide capture locations that specify locations of a sensor (e.g., an image capture device) relative to a component. Thus, in order to move the sensor into position, the location of the component is also identified so that the sensor can be moved into position. In some embodiments, the location and/or orientation of the engine and/or component is determined via markers on a cradle supporting the engine and/or the component. In some embodiments, the location and/or orientation of the engine and/or component is determined based on markers that are positioned on or near the component. The markers may comprise one or more optical markers, color-coded markers, shape-coded markers, pattern coded markers, embossed markers, engraved markers, sonar-readable markers, and/or lidar-readable markers.

In step 222, the inspection computer system 110 identifies capture locations. The capture locations may include coordinate locations relative to an inspection space, an engine, a component, or a portion of a component. For example, the capture locations may include XYZ coordinates for the positioning system 123 or a portion thereof relative to an inspection space, an engine, a component, or a portion of a component. In some embodiments, the capture locations may be provided directly from the inspection recipe. In other embodiments, the capture locations may be determined both from the inspection recipe and from the component location and orientation.

In step 223, the inspection computer system 110 determines movement for the positioning system 123. The inspection computer system 110 may determine a movement for the positioning system 123 to move one or more sensors of the sensor system 124 from an initial location to one or more of the capture locations. The movement may be a path or series of coordinate locations for the positioning system 123 or a portion thereof relative to an inspection space, an engine, a component, or a portion of a component. In one example, the positioning system 123 may move one or more sensors of the sensor system 124 to the capture locations. Thus, the movement may be a movement pattern, path, or series of coordinates of the sensor system 124. The sensor system 124 is moved into position using the positioning system 123. In another example, the engine and/or component is moved into position using a positioning system such as a rail system, turntable, etc. Thus, the movement may also be a movement of an engine or a component thereof. In some embodiments, the inspection computer system 110 determines a capture order for a plurality of capture locations. Further, the inspection computer system 110 determines machine instructions for the positioning system 123 which may specify movement of the positioning system 123 in accordance with the capture order.

In some embodiments, step 223 may be performed by an inspection operator rather than by the inspection computer system 110. For example, the user operated image capture device 126 may acquire the images at the capture locations. The inspection computer system 110 may provide the image capture locations to the user operated image capture device 126, which may display or otherwise communicate the image capture locations on the user interface 127. In this manner, an inspection operator may determine movement of the user operated image capture device 126 and may direct the user operated image capture device 126 to the capture locations.

In step 230A, the inspection computer system 110 instructs the positioning system 123 of the automated image capture device 122. The inspection computer system 110 may instruct the positioning system 123 to move as determined at step 223 in order to position one or more sensors of the sensor system 124 at the capture locations. In some embodiments, an inspection operator may manually move one or more sensors of the sensor system 128 to the capture locations.

In step 230B, the inspection computer system 110 then instructs one or more sensors of the image capture system 120 to capture images at the capture locations. The inspection computer system 110 may select at least one sensor of the image capture system 120 for each of the capture locations. The inspection computer system 110 may also determine an image capture configuration for each of the capture locations based on the inspection recipe. The inspection computer system 110 may provide image capture configuration instructions to the image capture system 120 based on the image capture configurations.

In step 240, the inspection computer system 110 may validate one or more images captured by the image capture system 120. In some approaches, validation involves determining whether the images meet one or more image requirements. The image requirements may be associated with the inspection recipe. Image requirements may include, for example, general focus, focus of a point of interest, amount of blur, exposure, brightness, overlap with adjacent images, identification of a part of the engine and/or component in an overlapping portion, presence of a part of the engine and/or component, etc. Image requirements may include one or more image quality metrics and may include any relevant image quality metrics.

In some embodiments, the inspection computer system 110 may compare one or more features of the images captured by the image capture system 120 to the inspection requirements. For example, the inspection computer system 110 may compare brightness level of the images to a required brightness level specified in the inspection requirements.

In some embodiments, the inspection computer system 110 may validate the images using machine learning. The machine learning models 136 may include one or more models trained using historical images tagged with inspection requirements (e.g., point of interest, amount of blur, exposure, brightness, etc.). For example, an inspection validation training data set may include captured images tagged to indicate whether the captured images meet one or more inspection requirements. The inspection validation training data set may include a plurality of captured images each tagged with an inspection location (e.g., indicating the capture location used to acquire the captured image), a captured configuration (e.g., indicating the sensor configuration used to acquire the captured image), and one or more inspection requirement indicators (e.g., indicating whether or not the captured image meets one or more inspection requirements). In some embodiments, the inspection validation training data set may be stored as training data 138. The inspection computer system 110 may use the inspection validation training data set to establish correlations between features of images that meet the inspection requirements (e.g., are satisfactory) and features of images that do not satisfy the inspection requirement (e.g., are deficient). In this manner, the trained machine learning model may automatically identify whether an image meets the inspection requirements based on such correlations. The trained machine learning model may receive images of an engine and/or a component thereof taken at one or more capture locations as an input. The trained machine learning model may identify whether images are satisfactory or deficient with respect to one or more inspection requirements as an output.

In step 245, the inspection computer system 110 determines updated instructions for the inspection. The inspection computer system 110 may determine the updated instructions based at least in part on image validation results. The updated instructions may identify one or more revised or additional capture locations for the image capture system 120. In addition, the updated instructions may include additional and/or revised capture configurations or settings for sensors of the image capture system 120. Further, the updated instructions may instruct additional image captures using one or more additional sensors, for example, sensors of different types or capabilities. The inspection computer system 110 may determine the revised capture configuration based on an image quality metric. In one non-limiting example, if the validation results indicate that the CNR of one or more images is deficient, the updated instructions may adjust the depth of focus with increasing F-stop. In another example, if the validation results indicate the presence of a part of the engine and/or component or the presence of a part of a component (e.g., a name plate) in an image, the updated instructions may instruct a camera to reposition on a quadrant (or quadrants) of the image that includes the part and may also instruct the camera to zoom-in or adjust focus to acquire a more detailed image of the part.

The updated instructions are provided to the image capture system 120. In this manner, the updated instructions may instruct the positioning system 123 to move to additional or revised capture locations. The inspection computer system 110 may provide machine instructions to the positioning system 123 based on the revised capture location. Further, the updated instructions may also instruct one or more sensors of the sensor system 124 and/or the sensor system 128 to capture images using revised capture configurations or settings. The inspection computer system 110 may also provide machine instruction to the sensor system 124 and/or the sensor system 128 based on the revised capture configuration. In some embodiments, the inspection computer system 110 may instruct the adjusted capture configuration to the image capture system 120 to recapture an image.

In some embodiments, the inspection computer system 110 may retrieve the updated instructions from the inspection database 130 based on deficient inspection requirements. For example, the inspection database 130 may include updated instructions that are associated with deficient inspection requirements. The updated instructions may be instructions intended to obtain satisfactory images and meet the inspection requirement previously identified as deficient. associated with the engine and/or a component of the engine.

In some embodiments, the inspection computer system 110 may determine updated instructions for the inspection using machine learning. The machine learning models 136 may include one or more models trained using historical images tagged with inspection requirements (e.g., point of interest, amount of blur, exposure, brightness, etc.) and/or tagged with updated instructions to meet deficient inspection requirements. For example, an instruction training data set may include captured images tagged to one or more deficient inspection requirements and tagged with updated instructions to be performed to satisfy the deficient inspection requirements. In some aspects, the instruction training data set may include a plurality of captured images each tagged with an inspection location, a capture configuration, and one or more updated instructions. The instruction training data set may be stored as training data 138. The inspection computer system 110 may use the instruction validation training data set to establish correlations between deficient inspection requirements (and/or image features) and updated instructions. In this manner, the trained machine learning model may automatically identify updated instructions for the image capture system 120 based on such correlations. The trained machine learning model may receive images of an engine and/or a component thereof and/or deficient inspection requirements associated with the image as an input. The trained machine learning model may identify updated instructions for inspection as an output.

In some embodiments, the adjusted capture configuration is determined based on a machine learning model trained with an image quality training data set. The machine learning model may be one of the machine learning models 136 and the image quality training data set may be stored as training data 138. The image quality training data set comprises a plurality of captured images each tagged with a capture location, a capture configuration, and a quality metric.

FIGS. 7A-7H illustrate exemplary positioning systems that may be used as the positioning system 123 in the image capture system 120. One or more of the positioning systems illustrated in FIGS. 7A-7H may be employed to position one or more sensors relative to a component 105 such as an engine or a component thereof.

FIG. 7A shows a gantry 123A or bay. The gantry 123A straddles the component 105. One or more sensors of the image capture system 120 are mounted to the gantry 123A. In some embodiments, the gantry 123A may include a crane or other device capable of lifting and/or repositioning the component 105. The gantry 123A may be configured to move one or more sensors of the image capture system 120 around or relative to the component 105 or a component thereof.

FIG. 7B shows a gantry 123B-1 on a rail system 123B-2. The gantry 123B-1 straddles the component 105. One or more sensors of the image capture system 120 are mounted to the gantry 123B-1. In some embodiments, the gantry 123A may include a crane or other device capable of lifting and/or repositioning the component 105. The gantry 123B-1 is configured to move one or more sensors of the image capture system 120 around or relative to the component 105 or a component thereof. The gantry 123B-1 is movable along the rails 123B-2 to reposition the gantry and the one or more sensors thereon relative to the component 105. The gantry 123B-I is configured to move one or more sensors of the image capture system 120 on a first plane. The rail system 123B-2 is configured to move the gantry 123B-1 in a direction perpendicular to the first plane.

FIG. 7C shows a powered vehicle 123C with a sensor 124C. The sensor 124C may include one or more sensors of the image capture system 120. The powered vehicle 123C is movable. Moving the powered vehicle 123C may reposition the sensor 124C around the component 105 or a component thereof. The powered vehicle 123C may include a programable mechanical arm that is configured to position the sensor 124C.

FIG. 7D shows a cable-suspended camera positioning system that includes a camera system 124D suspended by cables 123D. The cables 123D are configured to move and reposition the camera system 124D. Operating the cables 123D may move the camera system 124D relative to the component 105, which sits below the cables 123D.

FIG. 7E shows the component 105 positioned in an imaging bay 123E. The imaging bay 123E comprises a plurality of gantries. Each gantry is coupled to one or more sensors. Each gantry 123A may be configured to move one or more sensors of the image capture system 120 around or relative to the component 105 or a component thereof.

FIG. 7F shows a powered vehicle 123F-1 on a rail system 123F-2. The powered vehicle 123F-1 includes a sensor 124F. The sensor 124F may include one or more sensors of the image capture system 120. The powered vehicle 123F-1 may include a programable mechanical arm that is configured to position the sensor 124F.

FIG. 7G shows an aerial drone 123G that includes a sensor 124G. The sensor 124G may include one or more sensors of the image capture system 120. The aerial drone 123G may be configured to autonomously orient the sensor 124G relative to the component 105.

FIG. 7H shows the component 105 disposed on a turntable 124H-2. The component 105 is mounted on a cradle 124H-1 that supports the component 105. A sensor 124F may be mounted adjacent to the turntable 124H-2. The turntable 124H-2 is configured to turn the component 105 on an axis. The sensor 124F may include one or more sensors of the image capture system 120. In some embodiments, the sensor 124F is mounted to a programmable mechanical arm that is configured to position the sensor 124F.

FIG. 8 illustrates an exemplary embodiment of an image capture system 705. The image capture system 705 may be used as the image capture system 120. The image capture system 705 includes a frame 720 that supports the component 105 and a turning tool 745. The component 105 is suspended from the frame 720 via cables. In some embodiments, the turning tool 745 is configured to turn a part of the component such as the turbines of an engine. In some embodiments, the turning tool 745 is configured to tum or rotate the component 105 on the frame 720.

The image capture system 705 also includes a borescope inspection (BSI) device that has a mechanical arm 741 for positioning one or more sensors 742. The one or more sensors 742 are coupled to a distal end of the mechanical arm 741. The mechanical arm 741 is coupled to a base 740. The base 740 may be a cabinet housing one or more accessories and controllers 744 for the mechanical arm 741 and/or the one or more sensors 742. For example, the base 740 may store a battery, a router, a sidecar, etc. A user interface 743 may also be coupled to the base 740.

The image capture system 705 further includes an engine inspection service device. The EIS device includes a robotic arm 731 with one or more sensors 732 coupled thereto. The EIS device also includes a base 730. The robotic arm 731 and a user interface 733 are coupled to the base 730.

The image capture system 705 also includes an autonomous mobile robot (AMR) 710. The autonomous mobile robot 710 is configured to move through the inspection space surrounding the component 105 independently, for example, without tracks or operator oversight. The autonomous mobile robot 710 may also include one or more sensors coupled thereto.

The inspection systems and methods described herein may also allow for the dynamic adaptation of an initial work scope of engine MRO. The inspection methods may adapt the initial work scope of engine MRO. In addition, the inspection methods may guide imaging technology for different inspection situations and/or scenarios that may arise in the field.

In some approaches, a dynamic recipe generation method may conduct a further and/or a detailed interrogation of an identified region of interest (ROI).

In one scenario, condition assessment AI may identify a specific pre-defined ROI for further review, e.g., component missing, potential indications of defects, a component in the incorrect position. The method may automatically generate robot instructions to move an inspection robot, such as a robotic arm with cameras or other sensors (e.g., depth sensing, etc.), to the ROI, and collect additional data. The additional data may be additional images or additional information (e.g., depth information, etc.) from sensors at varying angles around the ROI under possibly varying lighting conditions to acquire additional details around the ROL Instruction generation for the acquisition of additional data may be automated and/or driven by AI. The automation of instruction generation may be learned offline, for example, via deep reinforcement learning. In some approaches, the inspection robot may learn how to move from a “bad” or low-quality image frame to a “good” or high-quality image frame. In another approach, the inspection robot may learn how to adjust lighting and/or camera parameters to improve image quality.

In another scenario, the inspection method may include an ad-hoc detailed inspection. For example, human inputs may initiate the ad-hoc detailed inspection to interrogate a random ROI that a human inspector deems necessary. The method may iteratively capture images and/or other sensor data about the ROI with the intent to achieve high-quality data of multiple points and, in some aspects, of every single point in the ROI. The quality metrics may be pre-defined and may include metrics such as sharpness, blurriness, etc., at the pixel level of images. The dynamic recipe generation method may generate a recipe dynamically and iteratively to ensure that all ROIs are covered with data that meets the quality metrics.

In other approaches, an automated recipe generation method may guide consistent imaging based on a variety of situations. For example, a situation may be assigned or may automatically determine a certain component part number and/or limits or criteria for inspections of the given part number and automatically generate a recipe based on such information. The method may programmatically retrieve information relevant to the given part number, including but not limited to: a) manuals on recommended work scopes and/or recipes on a number of potential indications at various regions of the part; b) historical inspection records of the given part number on locations and/or regions where inspections had been performed with the corresponding imaging recipes; and c) condition data patterns and/or heatmaps of regions with frequent detailed interrogations of a certain airline, service shop, flight route, etc. The method may combine these various types of retrieved information and automatically generate a series of recipes for imaging based on the retrieved information.

The inspection methods described herein may be applied to internal (e.g., borescope) inspection, airframe inspection, shop inspection, external inspection, etc. The methods may apply to all engine types and all components thereof that have service maintenance requirements that involve inspection-based work scope planning. It is contemplated that the inspection methods described herein may enable improved MRO and/or shop utilization by reducing the time required to obtain customer authorization and may reduce or prevent shop workflow disruptions. The inspection methods may also provide customers with visibility into repair workstreams. Further, the inspection methods may establish customer-specific parameters for work scope planning.

FIG. 9 illustrates an exemplary method for dynamic recipe generation to provide a detailed interrogation of a pre-defined region of interest. The method may be performed on an engine, such as an aircraft engine, or a component thereof. The method may be carried out based on communications between the inspection computer system 110 and the image capture system 120.

At step 220, the inspection computer system 110 determines an initial workscope for an inspection. The initial workscope is based on an inspection recipe. The inspection recipe may identify a component or a part of a component that is the target of the inspection. The inspection recipe may include a plurality of capture locations that specify locations at which the image capture system 120 is to capture images of the component or the part. The inspection recipe may also include image data requirements for images that are captured as part of the initial workscope. The initial workscope may also include initial instructions which may include capture instructions for the image capture system 120. The capture instructions may be machine instructions to the positioning system 123 for positioning one or more sensors of the image capture system relative to the engine and/or a component thereof. The capture instructions may also include machine instructions to one or more sensors of the sensor system 124, for example, that provide capture configurations or settings.

In some embodiments, the inspection recipe may be determined manually by an inspection operator. For example, an inspection operator may take images. In some embodiments, the inspection recipe is retrieved from the recipe database 132 based on an identifier associated with the engine and/or a component of the engine. The identifier, for example, may be a serial number, a model number, or a classification associated with the engine and/or a component thereof. In some approaches, the inspection computer system 110 may acquire the identifier from an image of the engine and/or a component thereof. For example, the identifier may be acquired from an image of a name plate or, in some aspects, from AI identification of a name plate in an image. In some embodiments, the inspection recipe and initial instructions are retrieved from the recipe database based on an engine or component configuration, for example, as determined based on an electronic drawing file or 3D model such as a CAD file associated with the engine and/or a component thereof. The inspection recipe may also be determined based on an engine inspection history, an engine configuration record, an engine repair history, a customer-specified mission requirement, and/or an identified issue.

In yet other embodiments, the inspection recipe is generated based on a recipe machine learning model trained on a plurality of images captured from a plurality of engines, a plurality of components, physical component models, and/or computer component models. The images in the training set may be tagged with image quality metrics identifying image and data qualities of the images. The plurality of images in the training set may also be tagged with a component identifier, a component repair history, a geographic region associated with the component, a component flight path history, and/or a component operator identifier. The plurality of images in the training data set may include images of components of the same or similar type, images of a component model, and/or images from a computer simulation of a component. Further details of the machine learning algorithm generated recipes are described with reference to FIG. 4. In some embodiments, an inspection operator may select the inspection recipe and/or initial instructions for the inspection using the user interface devices 140. In this manner, machine learning may determine recipes and inspection instructions (e.g., image capture locations and settings) that are most likely to yield high quality images.

In other embodiments, the inspection recipe and initial instructions may be determined via simulation on a 3D model such as a CAD model. For example, simulation on a 3D model may be used to determine image capture locations and settings that provide complete or adequate coverage of the engine and/or a component thereof.

In yet other embodiments, the inspection recipe is generated based on mapping with a computer-vision algorithm which reference images in a maintenance manual are associated with a computer model of the component.

In step 230, the inspection computer system 110 communicates instructions to the image capture system 120 based on the initial workscope. In some embodiments, the inspection computer system 110 communicates instructions to the positioning system 123 of the automated image capture device 122. The inspection computer system 110 may instruct the positioning system 123 to move one or more sensors of the sensor system 124 to the capture locations identified in the inspection recipe as part of the workscope. In some embodiments, an inspection operator may manually move one or more sensors of the sensor system 128 to the capture locations. In some embodiments, the inspection computer system 110 instructs one or more sensors of the image capture system 120 to capture images at the capture locations. The inspection computer system 110 may select at least one sensor of the image capture system 120 for each of the capture locations. The inspection computer system 110 may also determine an image capture configuration for each of the capture locations based on the inspection recipe. The inspection computer system 110 may provide image capture configuration instructions to the image capture system 120 based on the image capture configurations.

In step 235, the inspection computer system 110 receives a captured image. The inspection computer system 110 may receive one or more captured images that are taken as part of the initial workscope.

In step 247, the inspection computer system 110 identifies a trigger condition that is detected or identified based on the captured images. The trigger condition may be any condition that warrants one or more adapted tasks to be performed as part of the inspection workscope. The adapted tasks may include capturing images at one or more additional capture locations, with adjusted capture configurations or settings, and/or with new sensors, for example, sensors of different types. The adapted task may be warranted, for example, to acquire a complete set of inspection data, to acquire images of acceptable quality, or to perform detail integration of an area of interest such as an area with a detected anomaly. In some embodiments, the trigger condition is identified by comparing the captured image with image data requirements that are specified in the inspection recipe.

In some embodiments, the trigger condition includes captured images that do not pass validation. The inspection computer system 110 may be configured to validate the captured images for image quality and determine one or more images that do not pass validation. The validation may involve checking for one or more image quality metrics such as image resolution, lighting, sharpness, framing of a region of interest, or similar.

In some embodiments, the trigger condition may be detected using machine learning. The trigger condition may be detected based on performing a condition assessment of the component with a machine learning model that is trained on sample inspection images, and where the conditions are associated with the sample inspection images. The trigger condition may also be detected using a trigger condition machine learning model trained on a plurality of images tagged with trigger conditions. The trigger condition training data set may be stored as training data 138 and includes a plurality of images tagged with trigger conditions. At step 910, inspection computer system 110 processes the trigger condition training data. At step 911, the inspection computer system 110 trains a machine model using the trigger condition training data to develop a trigger condition model 136C. The trigger condition model 136C may receive one or more of the captured images as an input. Further, the trigger condition model 136C may automatically identify one or more trigger conditions as an output.

In yet other embodiments, the trigger condition may be detected based on a component identifier, a component repair history, a geographic region associated with the component use, a component flight path history, and/or a component operator identifier. For example, a component repair history that indicates a part of the component was previously repaired or replaced may be a trigger condition that warrants one or more adapted tasks to be performed to capture additional images of the part.

In some embodiments, the trigger condition comprises a detected anomaly in previously captured images. For example, an area of interest may correspond to an anomaly detected in the images based on comparing the captured images with reference images and/or based on condition assessment described with reference to FIG. 5. One or more adapted tasks may be performed to capture additional images of the area of anomaly to better assess the condition of the part.

In step 257, the inspection computer system 110 determines an adapted task for the inspection and instructs the image capture system 120 to perform the adapted task. The adapted task may comprise an image capture task at a new capture location. In some approaches, the new capture location is determined based on an estimated position of an area of interest determined based on one or more captured images. In some approaches, the new capture location may be determined based on simulating a movement of the positioning system 123 of the image capture system 120 with a computer model of the component. The adapted task may also comprise an image capture task with a new capture configuration and/or with a new sensor (e.g., a sensor of a different type or with different capabilities). The adapted task may also include a detailed interrogation task for an identified area of interest. In some approaches, the adapted task may also include a task to capture a plurality of images with varied capture configurations. The adapted task may also include a task to capture a plurality of images at a plurality of different capture locations and/or angles. Further, the adapted task may include a predefined set of capture locations around an identified area of interest.

The adapted task may be a task that provides updated instructions to the image capture system 120. In one example, the captured image is captured by a first sensor of the image capture system 120 and the updated instructions are configured to cause a second sensor of the image capture system 120 to capture an image. The new capture configuration may include one or more of a new zoom level, exposure time, light sensitivity setting, illumination setting, image resolution, video length, and sensor type selection. In another example, the captured image is captured with a first capture configuration and the updated instructions are configured to cause the image capture system 120 to capture an image with a second capture configuration. The inspection computer system 110 may determine the updated instructions based on a positioning system motion machine learning model. The positioning system motion machine learning model may be configured to determine a path from a first capture location of the captured image to a second capture location of the adapted task. The first capture location may be the location at which the captured image was acquired. The second capture location is the new location to which the positioning system may move per the adapted task. In some approaches, the positioning system motion machine learning model may be trained using captured images tagged with a first capture location, a second capture location, and a movement or motion path that takes a sensor from the first capture location to the second capture location.

In steps 270 and 278, the inspection computer system 110 determines a maintenance, repair, and overhaul (MRO) task and provides instructions to perform the MRO task. The inspection computer system 110 may provide instructions to the MRO system 141 to perform the MRO task. The MRO task may be a repair or maintenance task for the component or a portion thereof.

In some embodiments, the inspection computer system 110 may be configured to provide a review user interface to a user on one or more of the user interface devices 140. The inspection computer system 110 may transmit the captured image and/or the adapted task to the reviewer user interface for display. In addition, the inspection computer system 110 may determine instructions for the adapted task, at least in part, based on user input received via the reviewer user interface.

In step 280, the inspection computer system 110 may receive feedback on the trigger condition, the adapted task, and or the MRO task for a captured image. The inspection computer system 110 may then use this feedback to update the training data set and store it as further training data 138. For example, this feedback loop may provide real-time input into the training data set to fine tune machine learning models such as the trigger condition machine learning model.

Turning to FIG. 10, a method of providing dynamic recipe generation for detailed interrogation of a pre-defined region of interest is illustrated. The method may be performed on an engine, such as an aircraft engine, or a component thereof. The method may be carried out based on communications between the inspection computer system 110 and the image capture system 120.

At step 1010, the inspection computer system 110 starts the initial inspection for engine MRO. The initial inspection may be for inspection of engine externals or internals and, in some aspects, may focus on one or more components of the engine. The inspection computer system 110 may use one or more of the items at block 1020 to determine a recipe for the initial inspection of the engine. As shown in block 1020, one more of shop manuals, recommended workscope, recommended recipes, historical inspection records (e.g., by part number, serial number, part category, etc.), and condition data patterns or heatmaps (e.g., by airlines, shops, routes, etc.) may be used to determine or generate the recipe for the initial inspection.

Steps 1030-1033 detail an approach that uses machine learning models to identify regions of interest for detailed interrogation. The approach in steps 1030-1033 leverages machine learning based on captured images acquired from an initial inspection recipe.

At step 1030, the inspection computer system 110 identifies one or more predefined regions based on the recipe. The recipe provides a set of pre-defined regions of interest that identify portions of the engine for detailed interrogation. From the predefined regions of the engine, the inspection computer system 110 may then automatically identify one or more additional regions of interest for detailed interrogation using the approach described below.

At step 1031, the inspection computer system 110 causes the image capture system 120 to execute a set of pre-defined recipes for each region of interest. In this manner, the image capture system 120 captures a plurality of images and/or data in a detailed interrogation of each region of interest.

At step 1032, the inspection computer system 110 analyzes the captured images and/or data using a data quality checker to determine whether the captured images provide adequate or complete coverage of the region of interest. In some embodiments, the data quality checker performs the method described with reference to FIG. 6. If the data quality is not adequate, the method may return to step 1031 to perform additional image and/or data capture of the region of interest. If the data quality is adequate, the method proceeds to condition assessment at step 1033.

At step 1033, the inspection computer system 110 may also use condition assessment AI to analyze the captured images. The condition assessment AI may leverage ROI machine learning models to identify further regions of interest to interrogate based on the captured images. In some approaches, a training data set includes a plurality of captured images tagged with additional regions of interest and, in some approaches, recipes for interrogation associated with the additional regions of interest. In this manner, the ROI machine learning algorithm may receive a captured image as an input and identify further regions of interest and recipes for inspection the further regions of interest as an output.

Steps 1043-1052 detail an approach that uses input from an inspection operator to drive the identification of ad-hoc regions for detailed interrogation.

At step 1045, the inspection computer system 110 identifies one or more regions of interest (ROIs) based on the recipe. The recipe provides a set of pre-defined regions that identify portions of the engine for detailed interrogation.

At step 1040, an inspection operator and/or the inspection computer system 110 may identify or generate recipes for each region of interest to acquire captured images and/or data in a detailed interrogation. In some embodiments, an inspection operator may perform localization and pose estimation using the image capture system 120 to capture a plurality of images at various capture locations and with various capture configurations of the sensors. In other embodiments, the inspection computer system 110 may automatically instruct the image capture system 120 to capture a plurality of images, with the capture locations and capture configurations being predefined for a particular region of interest.

At step 1052, the inspection computer system 110 analyzes the captured images and/or data using a data quality checker to determine whether the captured images provide adequate or complete coverage of the region of interest. In some embodiments, the data quality checker performs the method described with reference to FIG. 6. If the data quality is not adequate, the method may return to step 1040 to perform additional image and/or data capture of the region of interest. Thus, the recipes at step 1040 may be iterative and may involve the capture of additional images and/or data until the data quality check determines adequate images and/or data has been collected of a region of interest. When the data quality is adequate, the method proceeds to step 1043.

At step 1043, one or more human operators may evaluate the captured images and/or data to determine if further detailed interrogations should be performed at one or more additional regions of interest. In some embodiments, a reviewer user interface may be displayed on one or more user interface devices 140. The reviewer user interface may display the captured images and/or data acquired of each region of interest. In some approaches, the display may map captured images to a 3D model or engineering drawing of the engine or a component thereof. An inspection operator may then input instructions to interrogate additional regions of interest into the reviewer user interface. In this manner, the inspection computer system 110 may determine instructions for further interrogation of regions of interest and communicate such instructions to the image capture system 120.

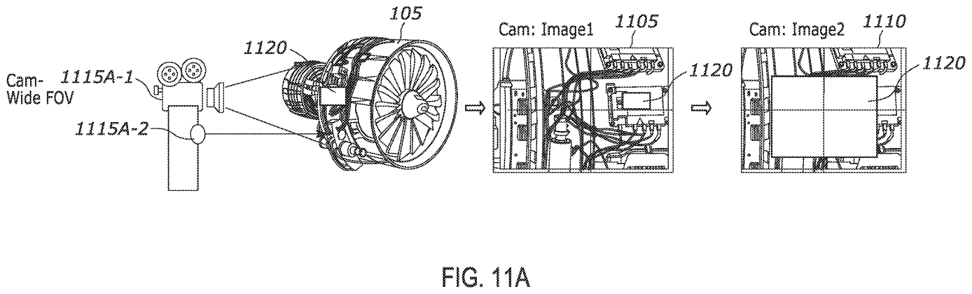

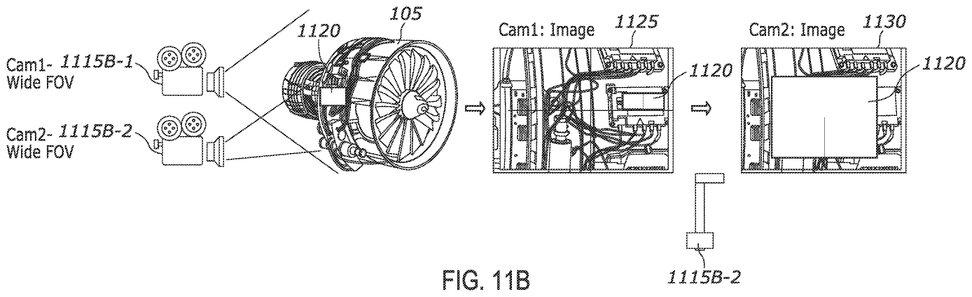

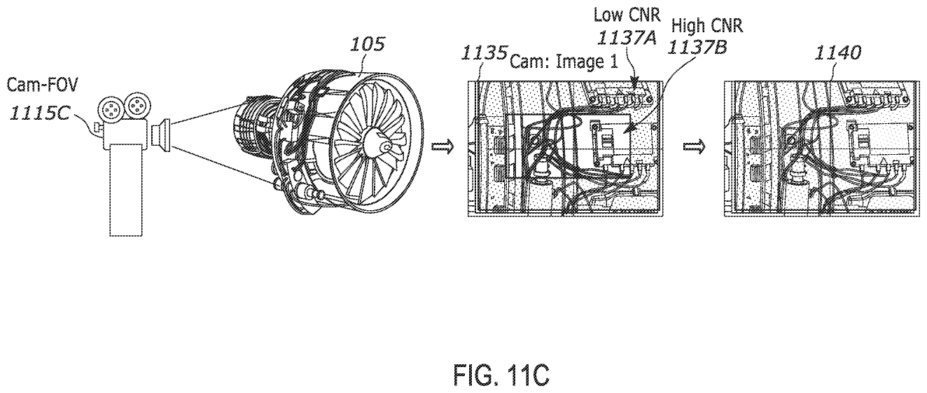

FIGS. 11A-11C show examples of images acquired using the image capture system 120. The images show captured images from an initial inspection recipe as well as additional images acquired for detailed interrogation of identified regions of interest and/or with altered captured configurations to provide improved data quality.

FIG. 11A illustrates a sensor 1115A-1 that captures images of the component 105. The sensor 1115A-1 is a camera having a wide field of view. A distance sensor 1115A-2 is associated with the sensor 1115A-1. The distance sensor 1115A-2 determines a distance from the sensor 1115A-1 to the component 105. The distance determines initial capture configuration for the sensor 1115A-1. In some approaches, input from a 3D model or engineering drawing of the engine may be used to determine the initial capture configuration for the sensor 1115A-1. The sensor 1115A-1 captures a first image 1105 of the component 105 using the initial capture configuration. Here, the initial capture configuration includes a large depth of field, low aperture, and an initial focus setting. A machine learning model, for example the trigger condition machine learning model and/or the ROI machine learning model, analyzes the first image 1105 and identifies an adapted task that includes instructions for capturing the second image 1110. The sensor 1115A-1 receives machine instructions for the adapted task and captures the second image 1110 of the component 105. The second image includes updated capture configurations and an updated capture location. The updated capture configuration adjusts the zoom level (e.g., zooms in on a region of interest) and the focus setting of the sensor 1115A-1. The adapted task provides instructions for a detailed interrogation of a region of interest 1120 that is identified using the ROI machine learning model.

FIG. 11B illustrates a first sensor 1115B-1 and a second sensor 1115B-2 that capture images of the component 105. The first sensor 1115B-1 is a camera having a wide field of view. The second sensor 1115B-2 is a camera having a narrow field of view. The first sensor 1115B-1 captures a first image 1125 of the component 105 using an initial capture configuration. Here, the initial capture configuration includes a large depth of field, low aperture, and an initial focus setting. A machine learning model, for example the trigger condition machine learning model and/or the ROI machine learning model, analyzes the first image 1125 and identifies an adapted task that includes instructions for capturing the second image 1130 using the second sensor 1115B-2. The instructions include movements to reposition the second sensor 1115B-2 to capture an image that focuses on region of interest 1120 that includes a name plate.

FIG. 11C illustrates a sensor 1115C that captures images of the component 105. The sensor 1115C captures a first image 1135 of the component 105 with an initial configuration. The inspection computer system 110 assesses the quality of the image using the approaches described with reference to FIG. 6. The first image 1135 has a first region 1137A with low CNR and a second region 1137B with high CNR. The inspection computer system 110 identifies updated capture instructions that adjust the depth of field with an increasing F-stop, and communicates the instructions to the sensor 1115C to capture the second image 1140. The second image 1140 has high F-stop to increase the depth of field.

The inspection systems and methods described herein may also include an engine inspection review and command center (RaCC). The RaCC may facilitate digital control and review of multi-modal inspection devices and data types, with automated tie-in to electronic manuals and AI-assisted disposition determination of engine, module, and piece part level inspection. The RaCC may also include large format image review to enable ergonomic and visual advantages for inspectors. The RaCC may also include automatic report generation which may save hours of labor formatting and curating germane disposition information. In some approaches, the RaCC may also enable a full digital inspection data record providing historical context for defect modes.

The RaCC may enable the command and control of a full suite of engine, module, and component inspection devices as part of an integrated, standardized, and automated inspection system.

The inspection systems and methods may include process and/or menu-directed control of devices to perform engine inspection via the RaCC. Using the RaCC, the inspection system may move mechanized engine stands into position and/or retrieve and position engine imaging equipment using a mobile robot and/or gantry-based systems. It may also be the center for directing borescope inspection (BSI) of the engine booster, compressor, and turbine. For example, once the inspection sequence is started, the RaCC may turn the engine core via a wireless Accessory Gear Box (AGB) motor.

The RaCC may include human aids such as augmented reality, computer vision for image acquisition and positioning, and remote assistance.

Following the process-driven data acquisition, the RaCC may also facilitate the automated collection and presentation of the data within the review center. Raw inspection data may be processed into useful information such as attribute tags, disposition of defects, serial number logging, ERP-integration, etc.

Further, the RaCC may enable the integration of electronic engine and/or aircraft manuals in-line with the inspection sequence, instead of requiring a separate workstation. The applicability of the RaCC may extend beyond repair or overhaul shops to aircraft maintenance facilities and on-wing.

Turning to FIG. 12, a method of inspection control is illustrated. The method may be performed to inspect an engine, such as an aircraft engine, or a component thereof. The method may be carried out based on communications between the inspection computer system 110 and the image capture system 120 and the user interface devices 140.

In step 235, the inspection computer system 110 receives captured images and metadata appended to the captured images. The captured images may be of a component of an aircraft or a part of a component. The inspection computer system 110 receives the captured images and appended metadata from the image capture system 120. The metadata may identify a view or a part of the component. In some aspects, the metadata may also identify a location of the captured image or a part identifier.

In step 1212, the inspection computer system 110 receives supplemental information. In some approaches, the inspection computer system 110 is communicatively coupled to a supplemental information database 1210 and receives the supplemental information from the supplemental information database 1210. The supplemental information may be any data relevant to the component and/or the inspection process. In some aspects, the supplemental information may include 3D models, manuals, technical specifications, repair options, maintenance instructions, replacement instructions, historical captured images, historical inspection data, or similar information associated with the component or a part of the component.

In some embodiments, the metadata identifies a view or a part of the component and the supplemental information comprises technical data and/or maintenance manual data associated with the part of the component. In some embodiments, the metadata identifies an issue with a part of the component and the supplemental information comprises repair options associated with the issue.

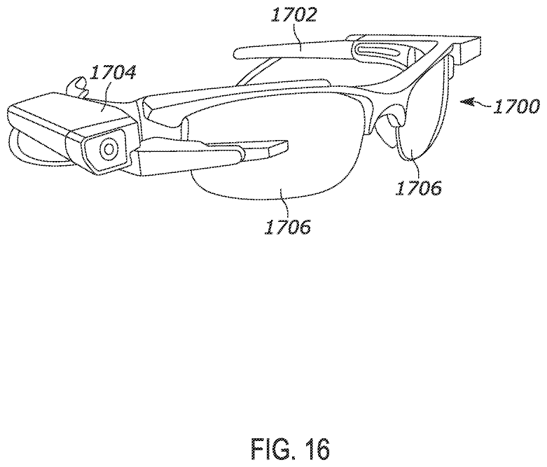

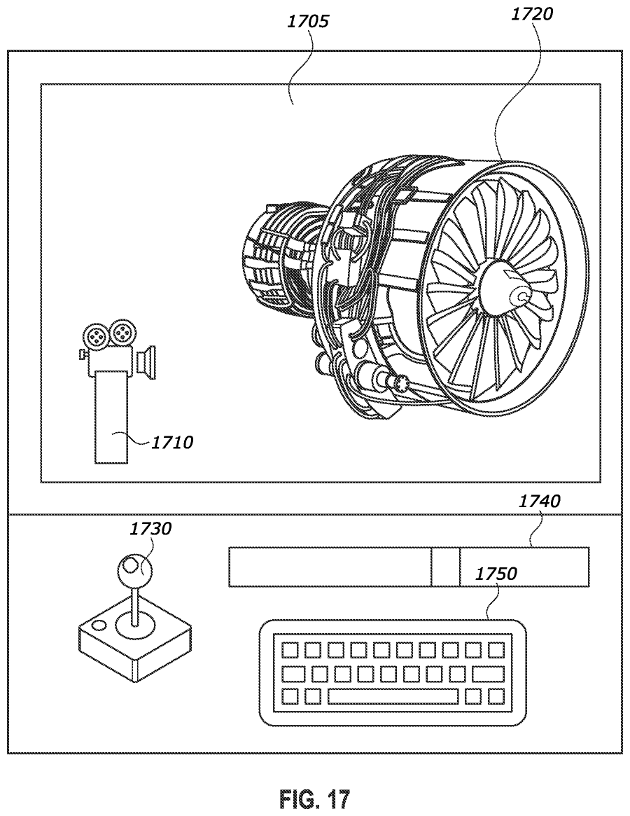

In step 1213, the inspection computer system 110 displays controls in a user interface via one or more of the user interface devices 140. The controls may be for one or more components of the image capture system 120. In some approaches, the controls of the image capture system 120 are displayed as overlays over a view of the sensor system 124 and/or the sensor system 128. The inspection computer system 110 may also display captured images acquired by the image capture system 120, appended metadata, as well as the supplemental information. In particular, the inspection computer system 110 provides an inspection user interface on a user interface device 140. The user interface device 140 may be any suitable interface device and, in some embodiments, may be a virtual, augmented, or mixed reality display. The user interface device 140 may be a head-mounted display (see e.g., FIG. 16) or may be a display screen with associated keyboard, numeric keypad, touch panel, control column, and/or control stick (see e.g., FIG. 17). In some approaches, the user interface device 140 comprises a control column or a control stick for controlling movement of the positioning system 123 or for reviewing images captured by the image capture system 120. The inspection user interface comprises controls for a plurality of sensors of the image capture system 120 and for a plurality of positioning devices in the positioning system 123 of the image capture system 120. In some embodiments, the controls may be selectively displayed concurrently on a display of the inspection user interface. For example, controls may be selectively displayed based on the inspection user interface, based on a part of the component being inspected, based on an inspection task being performed, and/or based on the inspection recipe or inspection instructions. In some examples, the controls may be selectively displayed based on a real-time image captured by the image capture system 120.

In some embodiments, the inspection user interface comprises a representation of the component of the aircraft and representations of sensors of the image capture system 120. The sensors of the image capture system 120 may be dragged and placed around the representation of the component. For example, an inspection operator may drag the representations of the sensors to place the sensors at various target positions on the representation of the component.

In some embodiments, the positioning system 123 comprises an engine turning device that is configured to rotate a part within an engine or the engine itself. The part may comprise turbine blades, disks, blisks, and/or shafts. The inspection user interface may comprise a first slider for controlling a rotation of the engine turning device. In some embodiments, the positioning system 123 comprises a component positioning system and a sensor positioning system.

In some embodiments, the inspection user interface comprises an image of the engine or of a component of the engine for selecting an insertion location of a borescope.

In yet other embodiments, the inspection computer system 110 may retrieve a captured image from the image capture system 120 with appended metadata and selectively display a subset of available controls for the positioning system 123 and sensors of the sensor system 124 based on the metadata of the captured image. The subset of available controls may be based on a location indicated in the captured image and/or a part identifier in the metadata.

At step 1214, the inspection computer system 110 receives user input for an inspection task. The user input may be received from a user such as an inspection operator via the inspection user interface. The inspection computer system 110 may be configured to control a motion of the component positioning system and the sensor positioning system concurrently to affect a relative position of the sensor system and the component for image capture. Thus, the user input may be any input to effect the component positioning system and/or the sensor positioning system. The user input may be a motion input captured by a motion sensor.

In some embodiments, when the user input device is a head-mounted display, the user input may comprise a movement and orientation of the head-mounted display. The inspection computer system 110 may be configured to control a movement of the image capture system 120 (e.g., of a component positioning system or sensor positioning system) based on the movement and orientation of the head-mounted display.

In some embodiments, the user input may comprise a touch input received on a touch sensitive display that displays an image of the component or a part of the component. The inspection computer system 110 may be configured to determine one or more capture locations based on the touch input and to determine a movement of one or more sensors of the image capture system 120 based on the one or more capture locations. The touch input may comprise a tap motion, a drag motion, and or a multi-touch pinch or stretch motion. In some approaches, a drag motion may correspond to a movement in a plane parallel to the image of the component and a pinch or stretch motion may correspond to a forward or backward movement relative to the plane.

In some embodiments, the inspection user interface may display a previously captured image or model of the component. The user input may comprise a user selection of an area of interest in the previously captured image. The inspection computer system 110 may then determine a capture location and/or capture configurations based on the area of interest. The capture location and the capture configurations may be selected to focus and/or enlarge the area of interest.

At step 1215, the inspection computer system 110 determines and communicates machine instructions. The inspection computer system 110 may determine and communicate machine instructions to the image capture system 120 or any portion thereof. The machine instructions may be machine instructions to the positioning system 123 to move the sensor system 124 to one or more capture locations. The machine instructions may also be configuration or setting instructions for the sensor system 124 or the sensor system 128 of the image capture system 120. The inspection computer system 110 may also determine and communicate instructions for a component positioning system or a sensor positioning system. In this manner, the machine instructions may effect image capture and result in additional images and appended metadata for step 235.

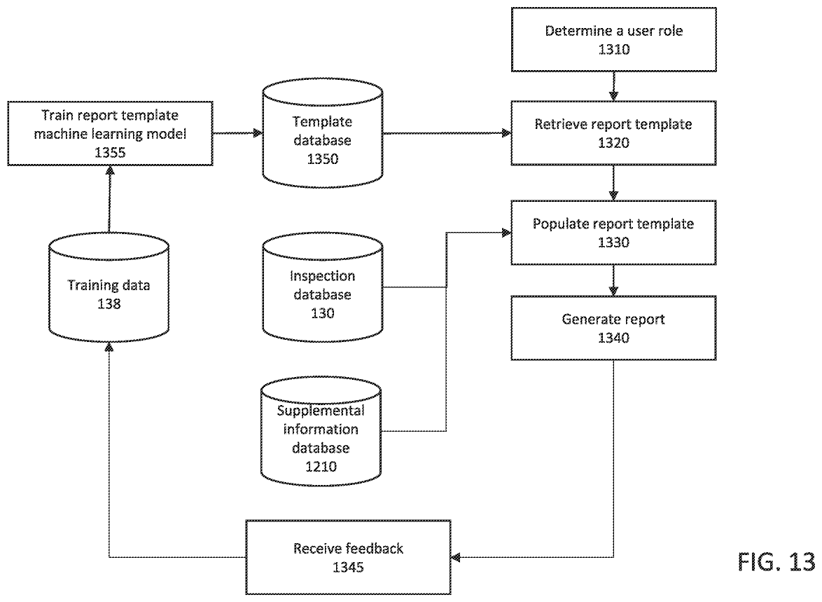

FIG. 13 shows a method of generating reports for an inspection. The method may be carried out based on communications between the inspection computer system 110 and the user interface devices 140.

In step 1310, the inspection computer system 110 determines a user role. The user role may be an inspector, an administrator, a customer, a vendor, or a reviewer role. In some embodiments, a user may make a selection on a user interface associated with a user interface device 140 to determine the user role. In other embodiments, the user role may be determined based on the inspection task or based on the captured images, inspection tasks, and/or MRO tasks determined during the inspection.

In step 1320, the inspection computer system 110 retrieves a report template from the template database 1350. The report templates may include information relevant to a particular user role. In this manner, the systems described herein may tailor reports and the information presented therein to a particular user role. For example, a report template may specify the types of metadata to include in the report. In another example, a report template can specify the selection of images/part data to include in the report based on the assessed condition of the parts. In yet another example, the report may specify whether images should be included in the report.

In some embodiments, at step 1355, the report template is generated by a report template machine learning model. The report template machine learning model may be one of the machine learning models 136. The report template machine learning model is trained on historical reports for a plurality of roles. The report training data set may be stored as training data 138 and may include historical reports tagged with a role and one or more items of information of known relevance for the role. The report training data set is used to train the report template machine learning model. The report template machine learning model is used to generate report templates, which may be stored in the template database 1350.

In step 1330, the inspection computer system 110 populates the report template with data from the inspection and/or with supplemental information. The inspection computer system 110 may selectively populate the report template with captured images and appended metadata that is stored in the inspection database 130. The inspection computer system 110 may retrieve inspection information, such as captured images, metadata, or other data acquired during the inspection, from the inspection database 130. The inspection computer system 110 may retrieve supplemental information from the supplemental information database 1210.

In step 1340, the inspection computer system 110 generates the report. The report may be provided to a user having one or more of the roles described herein. In some embodiments, the inspection computer system 110 may display the report on a user interface of a user interface device 140.

At step 1345, inspection computer system 110 may receive feedback on a report template. The feedback may be user feedback that indicates what information is relevant to a particular role. The feedback may be incorporated into the report training data set as training data 138 and may be used to further refine the report template machine learning model. A user may provide feedback for example via a user interface of a user interface device 140.

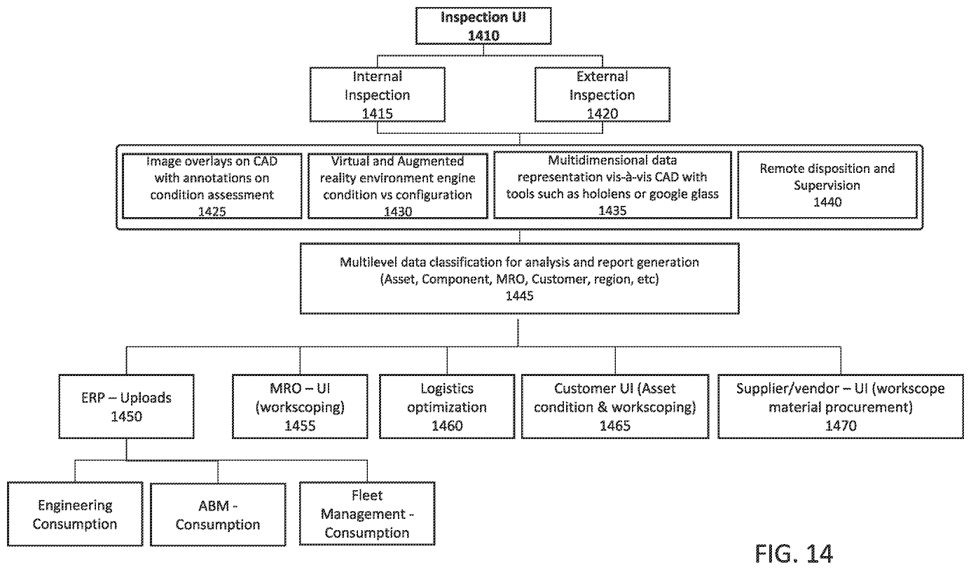

FIG. 14 shows a schematic diagram of information provided via an inspection user interface 1410, in accordance with some embodiments. In some embodiments, the user interfaces in FIG. 14 may be provided on a processor-based user interface device such as the user interface device 140 communicating with the inspection computer system 110 as described in FIG. 1. The inspection user interface 1410 may include an option for internal inspection 1415 of a component or for external inspection 1420 of a component. Either the internal inspection 1415 or the external inspection 1420 may include a plurality of options for representations of the inspection data on the inspection user interface 1410. The inspection user interface 1410 may include image overlays 1425 on a model, such as a CAD model, with inspection data or other annotations on condition assessment based on the inspection. The inspection user interface 1410 may also include a virtual or augmented reality environment view 1430 of the engine condition or configuration. A user may be able to manipulate the virtual or augmented reality representation of the engine to focus on a particular arca of interest. The inspection user interface 1410 may also include a multidimensional data representation 1435 of the engine vis-à-vis a model such as a CAD model with tools such as a head-mounted display device. The inspection user interface 1410 may also facilitate remote disposition determination of the engine or a component thereof and remote supervision 1440 of the inspection.

The inspection user interface 1410 may facilitate multilevel data classification 1445 for analysis and report generation. Inspection data from the image overlays 1425, the virtual or augmented reality environment view 1430, the multidimensional data representation 1435, and the remote disposition determination and inspection supervision 1440 may be classified and categorized for analysis and report generation. The inspection data may be categorized into one or more levels (e.g., asset, component, MRO, customer, region) for analysis and report generation.

The multilevel data classification 1445 may classify inspection data relevant to enterprise resource planning (ERP) for support processes in finance, human resources, manufacturing, supply chain, procurement, etc. Inspection data may be classified for ERP and consolidated in reports that are automatically transmitted to an ERP system 1450. For example, reports may be tailored to engineering consumption, analytics-based maintenance (ABM) consumption, and/or fleet management consumption. Inspection data or reports summarizing inspection data may be transmitted to one or more users or systems associated with engineering, ABM, and/or fleet management.

The multilevel data classification 1445 may classify inspection data for MRO. The inspection data may be classified for MRO and presented to a user via an MRO user interface 1455. The MRO user interface may facilitate workscoping of MRO tasks. The MRO user interface may provide a workscope describing a prescribed repair identified based on inspection data and the approach to repair or maintain the engine or component to meet requirements of a repair or maintenance specification. The MRO user interface 1455 may display one or more MRO tasks that define the scope of MRO to be performed based on inspection data.

The multilevel data classification 1445 may also classify inspection data for logistics optimization 1460. For example, during an inspection, data on one or more issues or defects may be identified. Based on the captured images and data acquired during an inspection, the inspection computer system 110 may automatically identify repairs or maintenance activities to address the issues or defects. These repairs or maintenance activities may be compiled into a report for logistics or may be automatically communicated to a logistics system for logistics optimization. For example, the identified repairs or maintenance activities may automatically trigger the ordering of materials or schedule maintenance personnel for logistics purposes.

The multilevel data classification 1445 may also classify data for a customer user interface 1465. The customer user interface 1465 may provide an asset condition identified as a result of the inspection process. The customer user interface 1465 may also provide workscoping that defines the scope of tasks to be performed on the asset based on the condition or other issues identified during the inspection process. For example, the customer user interface 1465 may display reports that detail a schedule of maintenance tasks to maintain the asset based on the condition of the asset as determined during the inspection.

The multilevel data classification 1445 may further classify data for a supplier and/or vendor user interface 1470. As discussed above, based on captured images and data acquired during an inspection, the inspection computer system 110 may automatically identify repairs or maintenance activities to address the issues or defects. These repairs or maintenance activities may be compiled into a report for logistics or may be automatically communicated to a logistics system for logistics optimization. For example, the identified repairs or maintenance activities may automatically place orders with a supplier or vendor to procure equipment or materials needed to perform the identified repairs or maintenance.

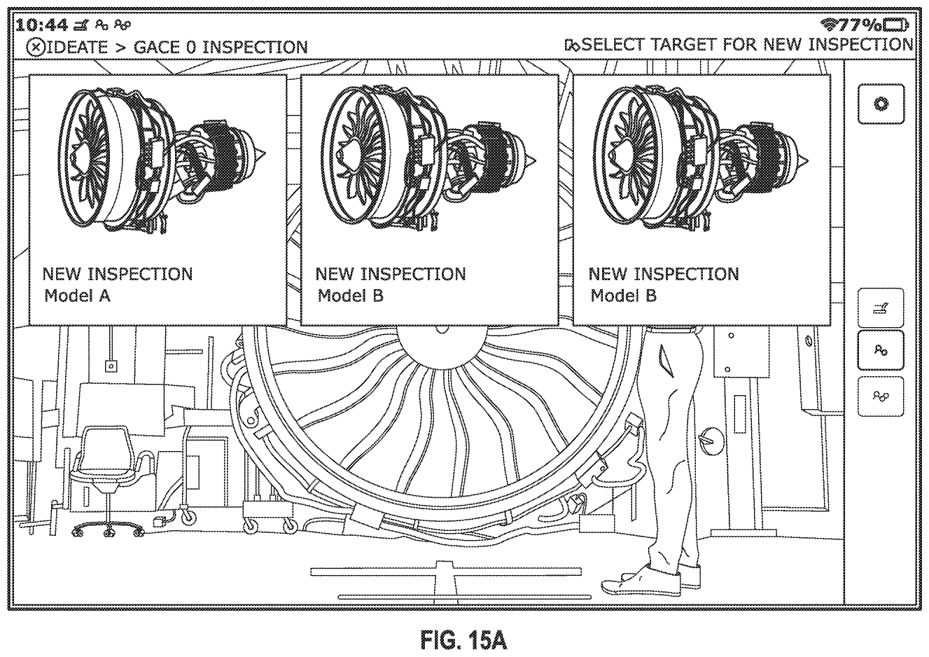

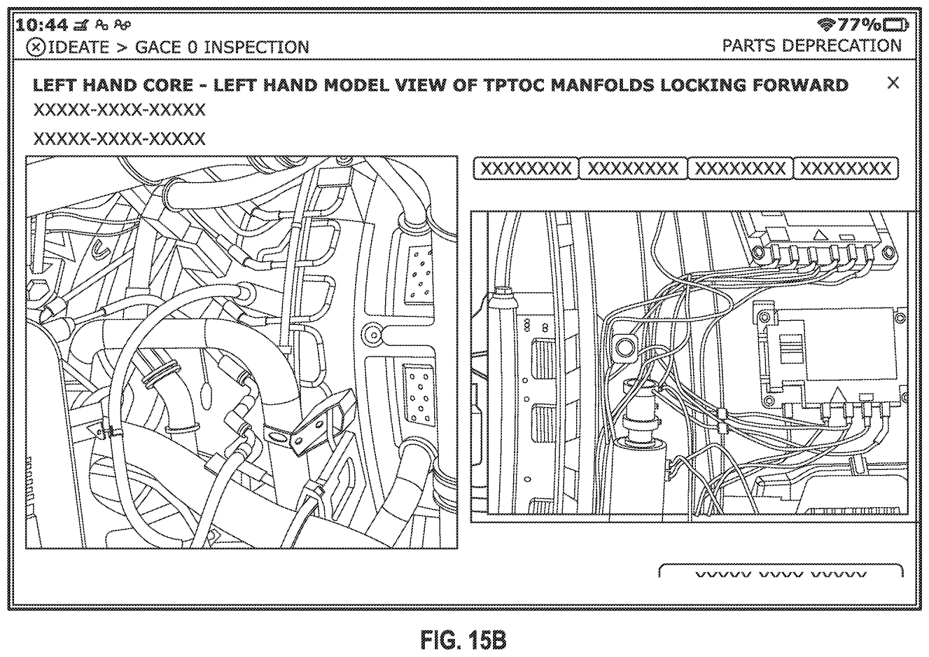

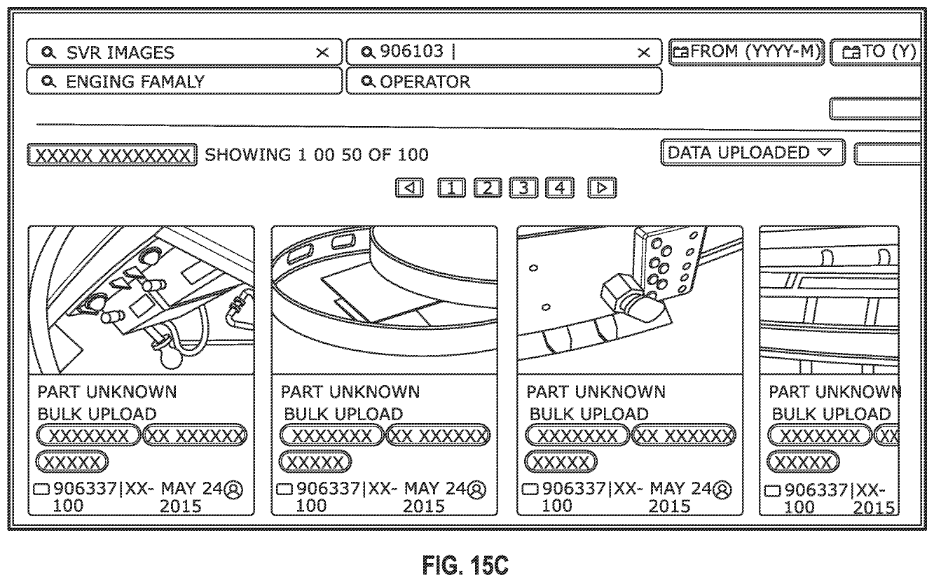

Turning now to FIGS. 15A-15C, exemplary inspection user interfaces are illustrated. In some embodiments, the user interfaces shown in FIGS. 15A-15C may be displayed via the user interface device 140 described with reference to FIG. 1.

FIG. 15A is an inspection user interface that allows for selection of a new inspection. The inspection user interface presents different types of inspections to an inspection operator. The types of inspection may involve different inspection recipes, An inspection operator may select an inspection via the inspection user interface.

FIG. 15B is an inspection user interface that provides a captured image from an inspection. A part in the captured image is selected and outlined on the user interface and the component is identified on the user interface. The user interface provides options for selecting the disposition of the part (e.g., installed, missing, damaged, not applicable). The user interface also includes a section for a user to input comments or notes on the part.

FIG. 15C shows an inspection user interface that displays captured images during an inspection. The captured images are tagged with metadata that indicates a date and time the images were captured. The user interface may be part of an inspection portal that provides inspection results and searchable images.

FIG. 16 shows a head-mounted display 1700. The head-mounted display 1700 may be used as the user interface device 140. The head-mounted display 1700 includes a sensor assembly 1704 that is configured to act as a sensory input that receives real-world information. The sensor assembly 1704 may include cameras, GPS trackers, accelerometers, and/or gyroscopes. The sensor assembly 1704 may capture images and track the movement and position of a user. The sensor assembly also includes near-eye displays 1706 configured to present visual data close to the eyes of a user. The head-mounted display also includes arms 1702 that extend back from the near-eye displays 1706 and are configured to mount on the head of a user.

FIG. 17 is an exemplary user interface device that includes a screen 1705. In some embodiments, the user interface device shown in FIG. 17 may be the user interface device 140 described with reference to FIG. 1. The screen 1705 displays an image of a sensor system 1710 coupled to a positioning system and an engine 1720 to be inspected. In some embodiments, the user interface device may include physical control elements such as a control stick or column 1730, a slider 1740, and a keypad 1750. Operation of the control column 1730 and the slider 1740 may control the movement of the positioning system and/or control the image display/playback on the screen 1705. The screen 1705 may also display images captured by the sensor system 1710.

Further aspects of the disclosure are provided by the subject matter of the following clauses:

An aircraft component inspection system including: an image capture system includes an image sensor system, a positioning system, and a processor communicatively coupled to the image sensor system and the positioning system, the processor being configured to: determine an inspection recipe based at least on an identifier associated with a component of an aircraft being inspected; identify a plurality of locations for performing image capture during an inspection workflow based on the inspection recipe; provide machine instructions to the positioning system to position the image sensor system relative to the component based on the plurality of locations; cause the image sensor system to capture images at the plurality of locations; and store the images with capture location in an inspection data database.

The system of any preceding clause, wherein the inspection recipe specifies an instructed image capture location associated with at least one required image, wherein the instructed image capture location includes a coordinate location relative to an inspection space, the component, or a part of the component.

The system of any preceding clause, wherein the inspection recipe specifies an instructed image capture orientation, including roll, pitch, and/or yaw of a sensor of the image sensor system.

The system of any preceding clause, wherein the inspection recipe specifies a view of the component for at least one required image, wherein the view of the component defines a size and/or an orientation of a portion of the component within an image frame.

The system of any preceding clause, wherein the processor is further configured to: provide capture instructions to the image capture system based on a location of the image capture system or a portion thereof.

The system of any preceding clause, wherein the positioning system includes a snake arm robot, and the machine instruction includes an instruction for controlling a movement of the snake arm robot.

The system of any preceding clause, wherein the processor is configured to validate the images captured prior to storing the images captured in the inspection data database.

The system of any preceding clause, wherein the images captured are validated by the processor based on a location of an image capture system and/or image quality.

The system of any preceding clause, wherein the inspection recipe identifies a portion of the component associated with a required image and the images captured are validated by the processor based on comparing the images captured with a computer model of the component, previously captured images from the component, and/or previously captured image from a similar component associated with the portion of the component.

The system of any preceding clause, wherein the processor is further configured to: identify a plurality of parts of the component based on the images captured; automatically determine a condition of a part based on at least one of the images captured; and determine a subsequent task based on the condition of the part.

The system of any preceding clause, wherein the condition of the part is identified using a machine learning model.

The system of any preceding clause, wherein the processor is further configured to determine a location and orientation of the component, and wherein the plurality of locations are identified further based on the location and orientation of the component.

The system of any preceding clause, wherein the location and orientation of the component is determined based on markers on or near the component, wherein the markers include an optical marker, a color-coded marker, a shape-coded marker, a pattern coded marker, an embossed marker, an engraved marker, a sonar-readable marker, and/or a lidar-readable marker.

The system of any preceding clause, wherein the processor is further configured to: determine an initial movement pattern for the positioning system based on the plurality of locations.

The system of any preceding clause, wherein the processor is configured to determine an image quality metric of the images; determine an adjusted capture configuration based on the image quality metric; and instruct the adjusted capture configuration to the image capture system to recapture at least one of the images.

The system of any preceding clause, wherein the machine instruction is determined by the processor based on simulating movements of the positioning system with a computer model of the component.

The system of any preceding clause, wherein the inspection recipe and/or an adapted task for the inspection workflow is determined by the processor based on an engine identifier, an engine inspection history, an engine configuration record, an engine repair history, a customer-specified mission requirement, and/or an identified issue.

The system of any preceding clause, wherein a new capture location is determined by the processor based on an estimated position of an area of interest determined based on one or more of the images.

The system of any preceding clause, the image capture system further including: a user interface device; wherein the processor is further configured to: provide an inspection user interface on the user interface device; receive user input via the inspection user interface for an inspection task; and determine and communicate machine instructions for the positioning system and one or more sensors of the image capture system based on the user input.

The system of any preceding clause, wherein the user input includes a touch input received on a touch sensitive display displaying an image of the component; wherein the processor is further configured to: determine one or more capture locations based on the touch input; determine a movement of one or more sensors of the image capture system based on the one or more capture locations; and communicate machine instructions to the image capture system to cause movement of one or more sensors of the image capture system to the one or more capture locations.

An aircraft component inspection system including: an image capture system; and a processor communicatively coupled to the image capture system, the processor being configured to: determine an inspection recipe based at least on an identifier associated with an aircraft component being inspected, the inspection recipe identifying a plurality of required images to be captured during an inspection workflow; determine an instruction for capturing at least one required image of a plurality of required images identified in the inspection recipe; communicate the instruction to the image capture system to cause an execution of the inspection task via the image capture system; receive a captured image from the image capture system in response to communicating the instruction; and append metadata to the captured image and store the captured image in an engine history of the engine in an inspection database.

An aircraft component inspection system including: an image capture system; and a processor communicatively coupled to the image capture system, the processor being configured to: receive one or more captured images from the image capture system; identify a plurality of components of an engine based on the one or more captured images; automatically determine a condition of a component based on the one or more captured images; and determine a subsequent task based on the conditions associated with the plurality of components of the engine.

An aircraft component inspection system including: an image sensor system; a positioning system; and a processor communicatively coupled to the image sensor system and the positioning system, the processor being configured to: determine an inspection recipe based at least on an identifier associated with a component of an aircraft being inspected, identify a plurality of locations for performing image capture during an inspection workflow based on the inspection recipe; provide machine instruction to the positioning system to position the image sensor system relative to the component based on the plurality of locations; cause the image sensor system to capture images at the plurality of locations; and store the images with capture location data in an inspection data database.

An aircraft component inspection system including: an image capture system; and a processor communicatively coupled to the image capture system, the processor being configured to: determine an initial workscope for the image capture system based on an inspection recipe; communication instructions to the image capture system based on the initial workscope; receive a captured image of a component of an aircraft from the image capture system; identify a task trigger based on the captured images; determine an adapted capture task based on the task trigger; and communicate updated instructions based on the adapted capture task to the image capture system during a performance of the workscope.

An aircraft component inspection system including: an image capture system including a positioning system and a sensor system configured to capture images of an aircraft component; a user interface device; and a processor communicatively coupled to the image capture system and the user interface device and configured to: provide an inspection user interface on the user interface device; receive user input via the inspection user interface for an inspection task; and generate machine instructions for the positioning system and the sensor system based on the user input.

An aircraft component inspection system including: an image capture system; and a processor communicatively coupled to the image capture system and configured to: receive, a captured image of a component from the image capture system with appended metadata; retrieve supplemental information from a database based on the metadata associated with the image; provide an inspection user interface for display on a user interface device; and cause the image to be displayed along with the supplemental information in the inspection user interface.

An aircraft component inspection system including: an image capture system; and a processor communicatively coupled to the image capture system and configured to: communicate capture instructions to the image capture system to capture images of a component of an aircraft for inspection; receive captured images from the image capture system in response to communicating the capture instructions; and store the captured images in an inspection database.

The system of any preceding clause, wherein the component includes an aircraft engine.

The system of any preceding clause, wherein the processor is further configured to: determine an inspection recipe based at least on an identifier associated with the component, wherein the inspection recipe identifies a plurality of required images to be captured during an inspection workscope; and receive a captured image from the image capture system in response to communicating the instruction; and store the captured image in a component history of the component in an inspection database; wherein the capture instructions are determined based on the plurality of required images.

The system of any preceding clause, wherein the inspection recipe is retrieved from a recipe database based on the identifier associated with the component.

The system of any preceding clause, wherein the inspection recipe is generated based on a recipe machine learning model trained on a plurality of sets of images captured from a plurality of components, physical component models, and/or computer component models.

The system of any preceding clause, wherein the inspection recipe is generated based on mapping, with a computer-vision algorithm, reference images in a maintenance manual associated with the component with a computer model of the component.

The system of any preceding clause, wherein the inspection recipe is generated based on simulating camera views on a computer model of the component to define a minimal set of views that cover predefined portions of the component.

The system of any preceding clause, wherein, the inspection recipe is determined based on a component inspection history, a component repair history, a customer-specified mission requirement, and/or an identified issue.

The system of any preceding clause, wherein the inspection recipe specifies an instructed image capture location associated with the at least one required image, wherein the instructed capture location includes a coordinate location relative to an inspection space, the component, or a part of a component.

The system of any preceding clause, wherein the inspection recipe specifies an instructed image capture location associated with the at least one required image, wherein the instructed capture location includes a distance from a part of the component.

The system of any preceding clause, wherein the inspection recipe specifies an instructed image capture orientation, including roll, pitch, and/or yaw of a sensor of the image capture system.

The system of any preceding clause, wherein the inspection recipes specifies a view of the component for the at least one required image, wherein the view of the component defines a size and/or an orientation of a portion of the component within an image frame.

The system of any preceding clause, wherein the inspection recipe specifies image type and/or an image capture system type for the at least one required image.

The system of any preceding clause, wherein the image capture system includes one or more of an optical sensor, an infrared sensor, a terahertz spectroscope, a microwave imaging sensor, an x-ray imager, a computed-tomography scanner, an eddy current imaging sensor, or an ultrasound imager.

The system of any preceding clause, wherein the image capture system includes a user interface device for displaying the instruction to a user.

The system of any preceding clause, wherein the instruction includes an augmented or mixed reality display displayed on the user interface device that overlays the instruction over a view of a portion of the component.

The system of any preceding clause, wherein the instruction displayed on the user interface device includes a reference image of a portion of the component to be captured, an outline of a portion of the component to be captured, and/or an image of the component with an identifier marking a location of the portion of the component to be captured.

The system of any preceding clause, wherein the processor is further configured to: identify an image capture system location relative to the component based on a location sensor on the image capture system, an image captured by the image captured system, or an image captured by a separate sensor system.

The system of any preceding clause, wherein the processor is further configured to: provide capture instructions to the image capture system based on the image capture system location.

The system of any preceding clause, wherein the processor is further configured to: determine an image capture system orientation, the capture instructions are further provided based on the image capture system orientation.

The system of any preceding clause, wherein the instruction is configured to automatically set an image capture configuration on the image capture system, wherein the image capture configuration includes zoom level, focal length, exposure time, light sensitivity setting, illumination setting, image resolution, video length, and/or sensor type selection.

The system of any preceding clause, wherein the image capture system includes a mobile computer, a mobile phone, a tablet computer, or a head-mounted display device.

The system of any preceding clause, further including a projection display device configured to project instructions from the instruction set onto surfaces of the component being inspected and/or around the component being inspected.

The system of any preceding clause, wherein the image capture system includes an autonomous ground vehicle, a robotic arm, a snake arm robotic, and/or a railed camera system, and the instruction includes machine instruction for controlling a movement of the image capture system.

The system of any preceding clause, further including a second image capture system, and the processor further configured to provide instructions to the image capture system and the second image capture system concurrently based on the recipe to capture the required images specified in the recipe.

The system of any preceding clause, wherein the processor is configured to validate the captured image prior to storing the image captured in the inspection database.

The system of any preceding clause, wherein the captured image is validated based on image capture system location and/or image quality.

The system of any preceding clause, wherein the inspection recipe identifies a portion of the component associated with the required image and the captured image is validated based on detecting, for the portion of the component in the captured image, machine object detection, machine feature detection, an object recognition algorithm, and/or an optical character recognition algorithm.

The system of any preceding clause, wherein the inspection recipe identifies a portion of the component associated with the required image and the captured image is validated based on comparing the captured image with a computer model of the component, previously captured image from the component, and/or previously captured image from a similar component associated with the portion of the component.

The system of any preceding clause, wherein the inspection recipe identifies a computer model of the component, and the captured image is validated based on identifying a gap in coverage by comparing the computer model and the captured image; wherein the processor is further configured to instruct additional capture tasks based on the gap in coverage.

The system of any preceding clause, wherein, in the event that the captured image does not pass validation, the processor is further configured to send an updated instruction to the image capture system instructing a recapturing of the required image.

The system of any preceding clause, wherein the processor is further configured to validate the inspection by comparing portions of the component imaged by images captured during the inspection workscope with a completeness requirement specified in the inspection recipe.

The system of any preceding clause, wherein the processor is further configured to: determine a workscope for a repair or maintenance task based on a plurality of images captured by the image capture system in response to receiving instructions from the processor.

The system of any preceding clause, wherein the processor is further configured to: identify an anomaly based on data recorded by the image capture system prior to a completion of the execution of the inspection workscope; and modify instructions communicated to the image capture system based on the anomaly.

The system of any preceding clause, wherein the processor is further configured to: append metadata to the captured image in the inspection database.

The system of any preceding clause, wherein the metadata includes an image capture system location, an image capture system orientation, an image capture system identifier, an imaged component location, a component identifier, and/or a time stamp.

The system of any preceding clause, wherein the inspection recipe associates the required image with a component part identifier, and the metadata includes the component part identifier.

The system of any preceding clause, wherein the metadata includes a component part identifier determined based on machine object detection, machine feature detection, an object recognition algorithm, and/or an optical character recognition algorithm.

The system of any preceding clause, wherein the metadata is superimposed on the captured image.

The system of any preceding clause, wherein the processor is further configured to: identify a plurality of parts of the component based on the captured images; automatically determine a condition of a part based on at least one of the captured images; and determine a subsequent task based on the conditions associated with the part.

The system of any preceding clause, wherein the plurality of parts are identified using a part identification machine learning model.

The system of any preceding clause, wherein the processor is further configured to: train the part identification machine learning model with a plurality of images of component parts and part identifiers associated with each of the component parts.

The system of any preceding clause, wherein the processor is further configured to: receive operator feedback on the identification of the plurality of parts, and further train the part identification machine learning model based on the feedback.

The system of any preceding clause, wherein the plurality of parts are identified based on identifying data plates associated with the plurality of parts in one or more of the captured images.

The system of any preceding clause, wherein the plurality of parts are identified based on an optical character recognition algorithm performed on one or more of the captured images.

The system of any preceding clause, wherein the plurality of parts are identified based on part shape, color, and/or on-component location appearing in one or more of the captured images.

The system of any preceding clause, wherein the condition of the part is identified based on detecting the presence of the part and/or anomalies in one or more images of the part.

The system of any preceding clause, wherein the condition of the part is identified using a part condition machine learning model.

The system of any preceding clause, wherein the processor is configured to train a part condition machine learning model using a training set including a plurality of images of one or more parts tagged with associated conditions.

The system of any preceding clause, wherein the processor is further configured to: train the part condition machine learning model with a plurality of images of a component part and condition identifiers associated with each image.

The system of any preceding clause, wherein the part condition machine learning model is further trained on context data associated with each image, wherein the context data includes customer data, geographic data, route data, assembly data, and service history data.

The system of any preceding clause, wherein the processor is further configured to: receive operator feedback on the identification of the condition of the part, and further train the part condition machine learning model based on the feedback.

The system of any preceding clause, wherein the condition of the part includes the presence or absence of the part, serviceability of the part, mission capability of the part, and/or maintenance or repair task of the part.

The system of any preceding clause, wherein in response to the condition of the part being absent or unserviceable, the processor is configured to forward a procurement request to a logistics system.

The system of any preceding clause, wherein the processor is further configured to compare the plurality of parts with records in an asset tracking database to determine authenticities, manufacturer, or origins of the plurality of parts.

The system of any preceding clause, wherein the processor is further configured to compare the plurality of parts with a set of manufacturing standards to determine standard compliance of the plurality of parts.

The system of any preceding clause, wherein the processor is further configured to compare conditions of one or more parts with a mission requirement profile to determine a mission suitability matric of the part.

The system of any preceding clause, wherein the processor is further configured to compare conditions of one or more parts with market value reference data to determine a market value of the component or one or more parts of the component.

The system of any preceding clause, wherein the subsequent task includes one or more replacement tasks, disassembly tasks, repair tasks, cleaning tasks, and/or further inspection tasks for one or more of the plurality of parts.

The system of any preceding clause, wherein the processor is further configured to determine an authorization status of the subsequent task based on the conditions of the plurality of parts and customer specified requirements.

The system of any preceding clause, wherein the authorization status of the subsequent task is further determined based on life and durability data associated with the component.

The system of any preceding clause, wherein the image capture system includes an image sensor system and a positioning system; and wherein the processor is configured to: identify a plurality of locations for performing image capture during an inspection workscope based on an inspection recipe; wherein the capture instructions include: machine instructions to the positioning system for positioning one or more sensors of the image sensor system relative to the component; and machine instructions to the one or more sensors of the image sensor system to capture images.

The system of any preceding clause, wherein the positioning system includes a gantry configured to move one or more sensors of the image sensor system around the component.

The system of any preceding clause, wherein the positioning system includes a plurality of gantries each coupled to one or more sensors of the image sensor system, forming an imaging bay.

The system of any preceding clause, wherein one or more sensors of the image sensor system are mounted on a gantry configured to move the one or more sensors on a first plane, and a rail system is configured to move the gantry in a direction perpendicular to the first plane.

The system of any preceding clause, wherein the positioning system includes a powered vehicle carrying one or more sensors of the image sensor system.

The system of any preceding clause, wherein the positioning system further includes a rail defining a path of the powered vehicle.

The system of any preceding clause, wherein the powered vehicle includes an aerial drone.

The system of any preceding clause, wherein the positioning system includes a cable-suspended camera positioning system.

The system of any preceding clause, wherein the positioning system includes a programable mechanical arm.

The system of any preceding clause, wherein the positioning system is mounted on a cradle supporting the component.

The system of any preceding clause, wherein the positioning system includes two or more of a gantry system, a rail system, a power vehicle, a component turntable, or a cable-suspended camera positioning system configured to concurrently move different sensors of the image sensor system to perform the inspection.

The system of any preceding clause, wherein the positioning system is configured to move the component relative to one or more stationary sensors of the image sensor system.

The system of any preceding clause, wherein the positioning system includes a turntable configured to turn the component on an axis.

The system of any preceding clause, wherein the image sensor system includes one or more of an optical sensor, a LIDAR, a 3D scanner, an infrared sensor, a terahertz spectroscope, a microwave imaging sensor, an x-ray imager, a computed-tomography scanner, an eddy current imaging sensor, or an ultrasound imager.

The system of any preceding clause, further including an illumination system and the processor is configured to provide lighting instructions to the illumination system based on the recipe.

The system of any preceding clause, wherein the inspection recipe specifies an instructed image capture location associated with at least one required image, wherein the instructed capture location includes a coordinate location relative to an inspection space, the component, or a part of a component.

The system of any preceding clause, wherein the inspection recipe specifies an instructed image capture orientation, including roll, pitch, and/or yaw of a sensor of the image capture system.

The system of any preceding clause, wherein the processor is further configured to determine a location and orientation of the component, and the plurality of locations are identified further based on the location and orientation of the component.

The system of any preceding clause, wherein the location and orientation of the component is determined via markers on a cradle supporting the component.

The system of any preceding clause, wherein the location and orientation of the component is determined based on markers on or near the component, wherein the markers include an optical marker, a color-coded marker, a shape-coded marker, a pattern coded marker, an embossed marker, an engraved marker, a sonar-readable marker, and/or a lidar-readable marker.

The system of any preceding clause, wherein the plurality of locations include sensor locations for locating one or more sensors of the image sensor system within an imaging space.

The system of any preceding clause, wherein the processor is further configured to select at least one sensor of the image sensor system for each of the plurality of locations based on the inspection recipe.

The system of any preceding clause, wherein the processor is further configured to determine an image capture configuration for each of the plurality of locations based on the inspection recipe, and provide capture configuration instructions to the image sensor system based on the image capture configuration.

The system of any preceding clause, wherein the image capture configuration includes zoom level, focal length, aperture, exposure time, light sensitivity setting, illumination setting, image resolution, video length, and/or sensor type selection.

The system of any preceding clause, wherein the processor is further configured to: determine an initial movement pattern of the positioning system based on the plurality of locations.

The system of any preceding clause, wherein the processor is further configured to select additional capture locations based on images captured by the image sensor system, and provide updated machine instruction to the positioning system based on the additional capture locations.

The system of any preceding clause, wherein the processor is further configured to validate a captured image based on image requirements in the inspection recipe.

The system of any preceding clause, wherein the image requirement includes focus, focus of a point of interest, amount of blur, exposure, brightness, overlap with adjacent images, identification of a part of the component in an overlapping portion, and presence of a part of the component.

The system of any preceding clause, wherein if the captured image does not meet the image requirements, the processor is configured to select a revised capture location and/or a revised capture configuration and provide machine instruction to the positioning system and/or image sensor system based on the revised capture location and/or the revised capture configuration.

The system of any preceding clause, wherein the processor is configured to: determine an image quality metric of a captured image; determine an adjusted capture configuration based on the image quality metric; and instruct the adjusted capture configuration to the image capture system to recapture an image.

The system of any preceding clause, wherein the adjusted capture configuration is determined based on a machine learning model trained with an image quality training data set including a plurality of captured images each tagged with a capture location, a captured configuration, and a quality metric.

The system of any preceding clause, wherein the machine instruction to the positioning system is determined based on simulating movements of the positioning system with a computer model of the component.

The system of any preceding clause, wherein the processor is configured to determine a capture order for the plurality of locations and the machine instruction for the positioning system is determined based on the capture order.

The system of any preceding clause, wherein the processor is further configured to: determine an initial workscope for the image capture system based on an inspection recipe; communicate instructions to the image capture system based on the initial workscope; identify a trigger condition based on the captured images; determine an adapted task based on the trigger condition; and communicate updated instructions based on the adapted task to the image capture system during a performance of the initial workscope.

The system of any preceding clause, wherein the inspection recipe includes image data requirements; and wherein the trigger condition is identified based on comparing the captured image with the image data requirements of the inspection recipe.

The system of any preceding clause, wherein the inspection recipe identifies a part of the component and the captured image is validated based on comparing the captured image with a computer model of the part, previously captured images from the part, and/or previously captured images from a similar part

The system of any preceding clause, wherein the inspection recipe is generated based on a machine learning model trained on a plurality of sets of images captured from a plurality of engines.

The system of any preceding clause, wherein the inspection recipe is generated based on mapping, with a computer-vision algorithm, reference images in a maintenance manual associated with the component with a computer model of the component.

The system of any preceding clause, wherein, the inspection recipe and/or the adapted task is determined based on an engine identifier, an engine inspection history, an engine configuration record, an engine repair history, a customer-specified mission requirement, and/or an identified issue.

The system of any preceding clause, wherein the inspection recipe is determined based on a recipe machine learning model trained by a plurality of images including a tagged image quality metric, component identifier, component repair history, a geographic region associated with the component, a component flight path history, and/or a component operator identifier.

The system of any preceding clause, wherein the plurality of images includes images of other components of the same or similar type, images of a component model, and images from a computer simulation of the component.

The system of any preceding clause, wherein the processor is further configured to validate the captured image for image quality, and the trigger condition includes the captured image not passing validation.

The system of any preceding clause, wherein image quality includes image resolution, lighting, sharpness, and/or framing of a region of interest.

The system of any preceding clause, wherein the captured image is validated based on whether a specified part of the component identified in the inspection recipe is visible in the captured image which is determined based on reference image comparison, machine object detection, machine feature defection, an object recognition algorithm, and/or an optical character recognition algorithm.

The system of any preceding clause, wherein the trigger condition includes a detection of an anomaly and/or an area of interest in the captured image.

The system of any preceding clause, wherein the trigger condition is detected based on performing a condition assessment of the component with a machine learning model trained on sample inspection images and conditions associated with the sample inspection images.

The system of any preceding clause, wherein the trigger condition is further detected based on a component identifier, a component repair history, a geographic region associated with the component use, a component flight path history, and/or a component operator identifier.

The system of any preceding clause, wherein the trigger condition is detected based on a plurality of captured images.

The system of any preceding clause, wherein the trigger condition is detected using a condition machine learning model trained on a plurality of images tagged with trigger conditions.

The system of any preceding clause, wherein the adapted task includes an image capture task at a new capture location and/or with a new capture configuration.

The system of any preceding clause, wherein the new capture configuration includes zoom level, exposure time, light sensitivity setting, illumination setting, image resolution, video length, and/or sensor type selection.

The system of any preceding clause, wherein the new capture location is determined based on an estimated position of an area of interest determined based on one or more captured images.

The system of any preceding clause, wherein the new capture location is determined based on simulating a movement of a positioning system of the image capture system with a computer model of the component.

The system of any preceding clause, wherein instructions for a movement of the positioning system is simulated using a machine learning model trained on real-world and/or simulated positioning system movements.

The system of any preceding clause, wherein the new capture location and/or the new capture configuration is determined based on an image capture machine learning model trained on a training data set including a plurality of images tagged with image qualities metrics, capture locations, and capture configurations.

The system of any preceding clause, wherein the new capture configuration is determined based on image quality analysis performed using one or more captured images.

The system of any preceding clause, wherein the adapted task includes a detailed interrogation task for an identified area of interest.

The system of any preceding clause, wherein the adapted task includes a task to capture a plurality of images with varied capture configurations.

The system of any preceding clause, wherein the adapted task includes a task to capture a plurality of images at a plurality of additional capture locations and/or angles.

The system of any preceding clause, wherein the adapted task includes a predefined set of capture locations around an identified area of interest.

The system of any preceding clause, wherein the adapted task includes a repair or maintenance task.

The system of any preceding clause, wherein the captured image is captured by a first sensor of the image capture system and the adapted capture instruction is configured to cause a second sensor of the image capture system to capture an image.

The system of any preceding clause, wherein the captured image is captured with a first capture configuration and the adapted capture instruction is configured to cause the image capture system to capture an image with a second capture configuration.

The system of any preceding clause, wherein the updated instructions are determined based on a positioning system motion machine learning model configured to determine a path from a first capture location of the captured image to a second capture location of the adapted task.

The system of any preceding clause, wherein the processor is further configured to: provide a reviewer user interface on a user interface device; transmit the captured image and/or the adapted task to the reviewer user interface for display; and determine the instructions for the adapted task based on user input received via the reviewer user interface.

The system of any preceding clause, further including: a user interface device; wherein the image capture system includes a positioning system and a sensor system configured to capture images of the component of the aircraft; wherein the processor is configured to: provide an inspection user interface on a user interface device; receive user input via the inspection user interface for an inspection task; and determine and communicate machine instructions for the positioning system and one or more sensors of the sensor capture system based on the user input.

The system of any preceding clause, wherein the inspection user interface includes controls for a plurality of sensors of the sensor system and a plurality of positioning devices of the positioning system that can be selectively displayed concurrently on a display of the user interface device.

The system of any preceding clause, wherein the inspection user interface includes a representation of the component of the aircraft and representations of sensors of the sensor system that may be dragged and placed around the representation of the component.

The system of any preceding clause, wherein the positioning system includes an engine turning device configured to rotate a part within an engine.

In some aspects, the techniques described herein relate to the system, wherein the part includes turbine blades, discs, blisks, and/or shafts.

The system of any preceding clause, wherein the inspection user interface includes a first slider for controlling a rotation of the engine turning device.

The system of any preceding clause, wherein the inspection user interface further includes an image of the engine for selecting an insertion location of a borescope.

The system of any preceding clause, wherein the processor is configured to determine a capture timing for the sensor system based on a movement of the positioning system and provide the machine instructions to the sensor system based on the capture timing.

The system of any preceding clause, wherein the positioning system includes a component positioning system and a sensor positioning system, and the processor is configured to control a motion of the component positioning system and the sensor positioning system concurrently to affect a relative position of the sensor system and the component for image captures.

The system of any preceding clause, wherein the user interface device includes a head-mounted display.

The system of any preceding clause, wherein the user input includes a movement and orientation of the head-mounted display, and the processor is configured to control a movement of the image capture device via the positioning system based on the movement and the orientation of the head-mounted display.

The system of any preceding clause, wherein the user input includes a touch input received on a touch sensitive display displaying an image of the component; wherein the processor is configured to: determine one or more capture locations based on the touch input; determine a movement of one or more sensors of the image capture system based on the one or more capture locations; and communicate machine instructions to the image capture system to cause the movement of one or more sensors of the image capture system to the one or more capture locations.

The system of any preceding clause, wherein the touch input includes a tap motion, a drag motion, and/or a multi-touch pinch or stretch motion.

The system of any preceding clause, wherein a drag motion corresponds to a movement in a plane parallel to the image of the component and a pinch or stretch motion corresponds to a forward or backward movement relative to the plane.

The system of any preceding clause, wherein the processor is configured to: display a previously captured image or a model of the component; receive a user selection of an area of interest in the previously captured image as the user input; and determine a capture location and/or a capture configuration based on the area of interest.

The system of any preceding clause, wherein the capture location and the capture configuration are selected to focus and enlarge the area of interest.

The system of any preceding clause, wherein the inspection user interface includes a virtual, augmented, or mixed reality display.

The system of any preceding clause, wherein controls of the image capture system are displayed as overlays over a view of the sensor system.

The system of any preceding clause, wherein the user input includes motion input captured by a motion sensor.

The system of any preceding clause, wherein the user interface device includes a control column or a control stick for controlling a movement of the positioning system and/or for reviewing images captured by the image capture system.

The system of any preceding clause, wherein the processor is further configured to: receive, a captured image from the image capture system with appended metadata; and selectively display a subset of available controls for the positioning system and the sensor system based on the metadata of the captured image.

The system of any preceding clause, wherein the subset of available controls is selected based on a location indicated and/or a part identifier in the metadata of the captured image.

The system of any preceding clause, wherein the processor is further configured to: retrieve, a captured image of a component captured by the image capture system and metadata associated with the captured image; retrieve supplemental information from a database based on the metadata associated with the image; provide an inspection user interface for display on a user interface device; and cause the image to be displayed along with the supplemental information on the inspection user interface.

The system of any preceding clause, wherein the metadata identifies a view or a part of the component, and the supplemental information includes technical or maintenance manual data associated with the part of the component.

The system of any preceding clause, wherein the metadata identifies an issue with a part of the component, and the supplemental information includes repair options associated with the issue.

The system of any preceding clause, wherein the processor is further configured to: identify a role associated with a user of the user interface device; retrieve a report template from a report template database based on the role associated with the user; and selectively populate the report template with captured images and associated metadata stored in an inspection database.

The system of any preceding clause, wherein the report template is generated by a report machine learning model trained on historical reports for a plurality of roles.

The system of any preceding clause, wherein the role is selected from an inspector, an administrator, a customer, a vendor, and a reviewer role.

An aircraft inspection method including: determining an inspection recipe based at least on an identifier associated with an aircraft component being inspected, the inspection recipe identifying a plurality of required images to be captured during an inspection workflow; determining an instruction for capturing at least one required image of a plurality of required images identified in the inspection recipe; communicating the instruction to the image capture system to cause an execution of the inspection task via the image capture system; receiving a captured image from the image capture system in response to communicating the instruction; and appending metadata to the captured image and store the captured image in an engine history of the engine in an inspection database.

An aircraft inspection method including: receiving one or more captured images from the image capture system; identifying a plurality of components of an engine based on the one or more captured images; automatically determining a condition of a component based on the one or more captured images; and determining a subsequent task based on the conditions associated with the plurality of components of the engine.

An aircraft inspection method including: determining an inspection recipe based at least on an identifier associated with a component of an aircraft being inspected, identifying a plurality of locations for performing image capture during an inspection workflow based on the inspection recipe; providing machine instruction to the positioning system to position the image sensor system relative to the component based on the plurality of locations; causing the image sensor system to capture images at the plurality of locations; and storing the images with capture location data in an inspection data database.

An aircraft inspection method including: determining an initial workscope for the image capture system based on an inspection recipe; communicating instructions to the image capture system based on the initial workscope; receiving a captured image of a component of an aircraft from the image capture system; identifying a task trigger based on the captured images; determining an adapted capture task based on the task trigger; and communicating updated instructions based on the adapted capture task to the image capture system during a performance of the workscope.

An aircraft inspection method including: providing an inspection user interface on the user interface device; receiving user input via the inspection user interface for an inspection task; and generating machine instructions for the positioning system and the sensor system based on the user input.

An aircraft inspection method including: receiving a captured image of a component from the image capture system with appended metadata; retrieving supplemental information from a database based on the metadata associated with the image; providing an inspection user interface for display on a user interface device; and causing the image to be displayed along with the supplemental information on the inspection user interface.

An aircraft inspection method including: communicating capture instructions to an image capture system to capture images of a component of an aircraft for inspection; receiving captured images from the image capture system in response to communicating the capture instructions; and storing the captured images in an inspection database.

The method of any preceding clause, wherein the component includes an aircraft engine.

The method of any preceding clause, further including: determining an inspection recipe based at least on an identifier associated with the component, wherein the inspection recipe identifies a plurality of required images to be captured during an inspection workscope; receiving a captured image from the image capture system in response to communicating the instruction; and storing the captured image in a component history of the component in an inspection database; wherein the capture instructions are determined based on the plurality of required images.

The method of any preceding clause, wherein the inspection recipe is retrieved from a recipe database based on the identifier associated with the component.

The method of any preceding clause, wherein the inspection recipe is generated based on a recipe machine learning model trained on a plurality of sets of images captured from a plurality of components, physical component models, and/or computer component models.

The method of any preceding clause, wherein the inspection recipe is generated based on mapping, with a computer-vision algorithm, reference images in a maintenance manual associated with the component with a computer model of the component.

The method of any preceding clause, wherein the inspection recipe is generated based on simulating camera views on a computer model of the component to define a minimal set of views that cover predefined portions of the component.

The method of any preceding clause, wherein, the inspection recipe is determined based on a component inspection history, a component repair history, a customer-specified mission requirement, and/or an identified issue.

The method of any preceding clause, wherein the inspection recipe specifies an instructed image capture location associated with the at least one required image, wherein the instructed capture location includes a coordinate location relative to an inspection space, the component, or a part of a component.

The method of any preceding clause, wherein the inspection recipe specifies an instructed image capture location associated with the at least one required image, wherein the instructed capture location includes a distance from a part of the component.

The method of any preceding clause, wherein the inspection recipe specifies an instructed image capture orientation, including roll, pitch, and/or yaw of a sensor of the image capture system.

The method of any preceding clause, wherein the inspection recipes specifies a view of the component for the at least one required image, wherein the view of the component defines a size and/or an orientation of a portion of the component within an image frame.

The method of any preceding clause, wherein the inspection recipe specifies image type and/or an image capture system type for the at least one required image.

The method of any preceding clause, wherein the image capture system includes one or more of an optical sensor, an infrared sensor, a terahertz spectroscope, a microwave imaging sensor, an x-ray imager, a computed-tomography scanner, an eddy current imaging sensor, or an ultrasound imager.

The method of any preceding clause, wherein the image capture system includes a user interface device for displaying the instruction to a user.

The method of any preceding clause, wherein the instruction includes an augmented or mixed reality display displayed on the user interface device that overlays the instruction over a view of a portion of the component.

The method of any preceding clause, wherein the instruction displayed on the user interface device includes a reference image of a portion of the component to be captured, an outline of a portion of the component to be captured, and/or an image of the component with an identifier marking a location of the portion of the component to be captured.

The method of any preceding clause, further including: identifying an image capture system location relative to the component based on a location sensor on the image capture system, an image captured by the image captured system, or an image captured by a separate sensor system.

The method of any preceding clause, further including: providing capture instructions to the image capture system based on the image capture system location.

The method of any preceding clause, further including: determining an image capture system orientation, wherein the capture instructions are further provided based on the image capture system orientation.

The method of any preceding clause, wherein the instruction is configured to automatically set an image capture configuration on the image capture system, and wherein the image capture configuration includes zoom level, focal length, exposure time, light sensitivity setting, illumination setting, image resolution, video length, and/or sensor type selection.

The method of any preceding clause, wherein the image capture system includes a mobile computer, a mobile phone, a tablet computer, or a head-mounted display device.

The method of any preceding clause, further including: projecting, with a projection display device configured, instructions from the instruction set onto surfaces of the component being inspected and/or around the component being inspected.

The method of any preceding clause, wherein the image capture system includes an autonomous ground vehicle, a robotic arm, a snake arm robotic, and/or a railed camera system, and the instruction includes machine instruction for controlling a movement of the image capture system.

The method of any preceding clause, further including: providing instructions to the image capture system and a second image capture system concurrently based on the recipe to capture the required images specified in the recipe.

The method of any preceding clause, further including: validating the captured image prior to storing the image captured in the inspection database.

The method of any preceding clause, wherein the captured image is validated based on image capture system location and/or image quality.

The method of any preceding clause, wherein the inspection recipe identifies a portion of the component associated with the required image and the captured image is validated based on detecting, for the portion of the component in the captured image, machine object detection, machine feature detection, an object recognition algorithm, and/or an optical character recognition algorithm.

The method of any preceding clause, wherein the inspection recipe identifies a portion of the component associated with the required image and the captured image is validated based on comparing the captured image with a computer model of the component, a previously captured image from the component, and/or a previously captured image from a similar component associated with the portion of the component.

The method of any preceding clause, wherein the inspection recipe identifies a computer model of the component, and the captured image is validated based on identifying a gap in coverage by comparing the computer model and the captured image; wherein the processor is further configure to instruction additional capture task based on the gap in coverage.

The method of any preceding clause, wherein, in the event that the captured image does not pass validation, the processor is further configured to send an updated instruction to the image capture system instructing a recapturing of the required image.

The method of any preceding clause, further including: validating the inspection by comparing portions of the component imaged by images captured during the inspection workscope with a completeness requirement specified in the inspection recipe.

The method of any preceding clause, further including: determining a workscope for a repair or maintenance task based on a plurality of images captured by the image capture system in response to receiving instructions from the processor.

The method of any preceding clause, further including: identifying an anomaly based on data recorded by the image capture system prior to a completion of the execution of the inspection workscope; and modifying instructions communicated to the image capture system based on the anomaly.

The method of any preceding clause, further including: appending metadata to the captured image in the inspection database.

The method of any preceding clause, wherein the metadata includes an image capture system location, an image capture system orientation, an image capture system identifier, an imaged component location, the component identifier, and/or a time stamp.

The method of any preceding clause, wherein the inspection recipe associates the required image with a component part identifier, and the metadata includes the component part identifier.

The method of any preceding clause, wherein the metadata includes a component part identifier determined based on machine object detection, machine feature detection, an object recognition algorithm, and/or an optical character recognition algorithm.

The method of any preceding clause, wherein the metadata is superimposed on the captured image.

The method of any preceding clause, further including: identifying a plurality of parts of the component based on the captured images; automatically determining a condition of a part based on at least one of the captured images; and determining a subsequent task based on the conditions associated with the part.

The method of any preceding clause, wherein the plurality of parts are identified using a part identification machine learning model.

The method of any preceding clause, further including: training the part identification machine learning model with a plurality of images of component parts and part identifiers associated with each of the component parts.

The method of any preceding clause, further including: receiving operator feedback on the identification of the plurality of parts, and further training the part identification machine learning model based on the feedback.

The method of any preceding clause, wherein the plurality of parts are identified based on identifying data plates associated with the plurality of parts in one or more of the captured images.

The method of any preceding clause, wherein the plurality of parts are identified based on an optical character recognition algorithm performed on one or more of the captured images.

The method of any preceding clause, wherein the plurality of parts are identified based on part shape, color, and/or on-component location appearing in one or more of the captured images.

The method of any preceding clause, wherein the condition of the part is identified based on detecting the presence of the part and/or anomalies in one or more images of the part.

The method of any preceding clause, wherein the condition of the part is identified using a part condition machine learning model.

The method of any preceding clause, further including: training a part condition machine learning model using a training set including a plurality of images of one or more parts tagged with associated conditions.

The method of any preceding clause, further including: training the part condition machine learning model with a plurality of images of a component part and condition identifiers associated with each image.

The method of any preceding clause, wherein the part condition machine learning model is further trained on context data associated with each image, wherein the context data includes customer data, geographic data, route data, assembly data, and service history data.

The method of any preceding clause, further including: receiving operator feedback on the identification of the condition of the part, and further training the part condition machine learning model based on the feedback.

The method of any preceding clause, wherein the condition of the part includes the presence or absence of the part, serviceability of the part, mission capability of the part, and/or maintenance or repair task of the part.

The method of any preceding clause, wherein in response to the condition of the part being absent or unserviceable, the processor is configured to forward a procurement request to a logistics system.

The method of any preceding clause, further including: comparing the plurality of parts with records in an asset tracking database to determine authenticities, manufacturer, or origins of the plurality of parts.

The method of any preceding clause, further including: comparing the plurality of parts with a set of manufacturing standards to determine standard compliance of the plurality of parts.

The method of any preceding clause, further including: comparing conditions of one or more parts with a mission requirement profile to determine a mission suitability matric of the part.

The method of any preceding clause, further including: comparing conditions of one or more parts with market value reference data to determine a market value of the component or one or more parts of the component.

The method of any preceding clause, wherein the subsequent task includes one or more replacement tasks, disassemble tasks, repair tasks, cleaning tasks, and/or further inspection tasks for one or more of the plurality of parts.

The method of any preceding clause, further including: determining an authorization status of the subsequent task based on the conditions of the plurality of parts and customer specified requirements.

The method of any preceding clause, wherein the authorization status of the subsequent task is further determined based on lifing and durability data associated with the component.

The method of any preceding clause, wherein the image capture system includes an image sensor system and a positioning system; and further including: identifying a plurality of locations for performing image capture during an inspection workscope based on an inspection recipe; wherein the capture instructions include: machine instructions to the positioning system for positioning one or more sensors of the image sensor system relative to the component; and machine instructions to the one or more sensors of the image sensor system to capture images.

The method of any preceding clause, wherein the positioning system includes a gantry configured to move one or more sensors of the image sensor system around the component.

The method of any preceding clause, wherein the positioning system includes a plurality of gantries each coupled to one or more sensors of the image sensor system, forming an imaging bay.

The method of any preceding clause, wherein one or more sensors of the image sensor system are mounted on a gantry configured to move the one or more sensors on a first plane, and a rail system is configured to move the gantry in a direction perpendicular to the first plane.

The method of any preceding clause, wherein the positioning system includes a powered vehicle carrying one or more sensors of the image sensor system.

The method of any preceding clause, wherein the positioning system further includes a rail defining a path of the powered vehicle.

The method of any preceding clause, wherein the powered vehicle includes an aerial drone.

The method of any preceding clause, wherein the positioning system includes a cable-suspended camera positioning system.

The method of any preceding clause, wherein the positioning system includes a programable mechanical arm.

The method of any preceding clause, wherein the positioning system is mounted on a cradle supporting the component.

The method of any preceding clause, wherein the positioning system includes two or more of a gantry system, a rail system, a power vehicle, a component turntable, or a cable-suspended camera positioning system configured to concurrently move different sensors of the image sensor system to perform the inspection.

The method of any preceding clause, further including: moving the component relative to one or more stationary sensors of the image sensor system.

The method of any preceding clause, wherein the positioning system includes a turntable configured to tum the component on an axis.

The method of any preceding clause, wherein the image sensor system includes one or more of an optical sensor, a LIDAR, a 3D scanner, an infrared sensor, a terahertz spectroscope, a microwave imaging sensor, an x-ray imager, a computed-tomography scanner, an eddy current imaging sensor, or an ultrasound imager.

The method of any preceding clause, further including: provide lighting instructions to an illumination system based on the recipe.

The method of any preceding clause, wherein the inspection recipe specifies an instructed image capture location associated with at least one required image, wherein the instructed capture location includes a coordinate location relative to an inspection space, the component, or a part of a component.

The method of any preceding clause, wherein the inspection recipe specifies an instructed image capture orientation, including roll, pitch, and/or yaw of a sensor of the image capture system.

The method of any preceding clause, further including: determining a location and orientation of the component, and wherein the plurality of locations are identified further based on the location and orientation of the component.

The method of any preceding clause, wherein the location and orientation of the component is determined via markers on a cradle supporting the component.

The method of any preceding clause, wherein the location and orientation of the component is determined based on markers on or near the component, wherein the markers includes an optical marker, a color-coded marker, a shape-coded marker, a pattern coded marker, an embossed marker, an engraved marker, a sonar-readable marker, and/or a lidar-readable marker.

The method of any preceding clause, wherein the plurality of locations include sensor locations for locating one or more sensors of the image sensor system within an imaging space.

The method of any preceding clause, further including: selecting at least one sensor of the image sensor system for each of the plurality of locations based on the inspection recipe.

The method of any preceding clause, further including: determining an image capture configuration for each of the plurality of locations based on the inspection recipe, and providing capture configuration instructions to the image sensor system based on the image capture configuration.

The method of any preceding clause, wherein the image capture configuration includes zoom level, focal length, aperture, exposure time, light sensitivity setting, illumination setting, image resolution, video length, and/or sensor type selection.

The method of any preceding clause, further including: determining an initial movement pattern of the positioning system based on the plurality of locations.

The method of any preceding clause, further including: selecting additional capture locations based on images captured by the image sensor system, and providing updated machine instruction to the positioning system based on the additional capture locations.

The method of any preceding clause, further including: validating a captured image based on image requirements in the inspection recipe.

The method of any preceding clause, wherein the image requirement includes focus, focus of a point of interest, amount of blur, exposure, brightness, overlap with adjacent images, identification of a part of the component in an overlapping portion, and presence of a part of the component.

The method of any preceding clause, wherein if the captured image does not meet the image requirements, the processor is configured to select a revised capture location and/or a revised capture configuration and provide machine instruction to the positioning system and/or image sensor system based on the revised capture location and/or the revised capture configuration.

The method of any preceding clause, further including: determining an image quality metric of a captured image; determining an adjusted capture configuration based on the image quality metric; and instructing the adjusted capture configuration to the image capture system to recapture an image.

The method of any preceding clause, wherein the adjust capture configuration is determined based on a machine learning model trained with an image quality training data set including a plurality of captured images each tagged with a capture location, a captured configuration, and a quality metric.

The method of any preceding clause, wherein the machine instruction to the positioning system is determined based on simulating movements of the positioning system with a computer model of the component.

The method of any preceding clause, further including: determining a capture order for the plurality of locations, and wherein the machine instruction for the positioning system is determined based on the capture order.

The method of any preceding clause, further including determining an initial workscope for the image capture system based on an inspection recipe; communicating instructions to the image capture system based on the initial workscope; identifying a trigger condition based on the captured images; determining an adapted task based on the trigger condition; and communicating updated instructions based on the adapted task to the image capture system during a performance of the initial workscope.

The method of any preceding clause, wherein the inspection recipe includes image data requirements; and wherein the trigger condition is identified based on comparing the captured image with the image data requirements of the inspection recipe.

The method of any preceding clause, wherein the inspection recipe identifies a part of the component and the captured image is validated based on comparing the captured image with a computer model of the part, previously captured images from the part, and/or previously captured images from a similar part

The method of any preceding clause, wherein the inspection recipe is generated based on a machine learning model trained on a plurality of sets of images captured from a plurality of engines.

The method of any preceding clause, wherein the inspection recipe is generated based on mapping, with a computer-vision algorithm, reference images in a maintenance manual associated with the component with a computer model of the component.

The method of any preceding clause, wherein, the inspection recipe and/or the adapted task is determined based on an engine identifier, an engine inspection history, an engine configuration record, an engine repair history, a customer-specified mission requirement, and/or an identified issue.

The method of any preceding clause, wherein the inspection recipe is determined based on a recipe machine learning model trained by a plurality of images including tagged image quality metric, component identifier, component repair history, a geographic region associated with the component, a component flight path history, and/or a component operator identifier.

The method of any preceding clause, wherein the plurality of images includes images of other components of the same or similar type, images of a component model, and images from a computer simulation of the component.

The method of any preceding clause, further including: validating the captured image for image quality, and wherein the trigger condition includes the captured image not passing validation.

The method of any preceding clause, wherein image quality includes image resolution, lighting, sharpness, and/or framing of a region of interest.

The method of any preceding clause, wherein the captured image is validated based whether a specified part of the component identified in the inspection recipe in visible in the captured image based on reference image comparison, machine object detection, machine feature defection, an object recognition algorithm, and/or an optical character recognition algorithm.

The method of any preceding clause, wherein the trigger condition includes a detection of an anomaly and/or an area of interest in the captured image.

The method of any preceding clause, wherein the trigger condition is detected based on performing a condition assessment of the component with a machine learning model trained on sample inspection images and conditions associated with the sample inspection images.

The method of any preceding clause, wherein the trigger condition is further detected based on a component identifier, a component repair history, a geographic region associated with the component use, a component flight path history, and/or a component operator identifier.

The method of any preceding clause, wherein the trigger condition is detected based on a plurality of captured images.

The method of any preceding clause, wherein the trigger condition is detected using a condition machine learning model trained on a plurality of images tagged with trigger conditions.

The method of any preceding clause, wherein the adapted task includes an image capture task at a new capture location and/or with a new capture configuration.

The method of any preceding clause, wherein the new capture configuration includes zoom level, exposure time, light sensitivity setting, illumination setting, image resolution, video length, and/or sensor type selection.

The method of any preceding clause, wherein the new capture location is determined based on an estimated position of an area of interest determined based on one or more captured images.

The method of any preceding clause, wherein the new capture location is determined based on simulating a movement of a positioning system of the image capture system with a computer model of the component.

The method of any preceding clause, wherein instructions for a movement of the positioning system is simulated using a machine learning model trained on real-world and/or simulated positioning system movements.

The method of any preceding clause, wherein the new capture location and/or the new capture configuration is determined based on an image capture machine learning model trained on a training data set including a plurality of images tagged with image qualities metrics, capture locations, and capture configurations.

The method of any preceding clause, wherein the new capture configuration is determined based on image quality analysis performed using one or more captured images.

The method of any preceding clause, wherein the adapted task includes a detailed interrogation task for an identified area of interest.

The method of any preceding clause, wherein the adapted task includes a task to capture a plurality of images with varied capture configurations.

The method of any preceding clause, wherein the adapted task includes a task to capture a plurality of images at a plurality of additional capture locations and/or angles.

The method of any preceding clause, wherein the adapted task includes a predefined set of capture locations around an identified area of interest.

The method of any preceding clause, wherein the adapted task includes a repair or maintenance task.

The method of any preceding clause, wherein the captured image is captured by a first sensor of the image capture system and the adapted capture instruction is configured to cause a second sensor of the image capture system to capture an image.

The method of any preceding clause, wherein the captured image is captured with a first capture configuration and the adapted capture instruction is configured to cause the image capture system to capture an image with a second capture configuration.

The method of any preceding clause, wherein the updated instructions are determined based on a positioning system motion machine learning model configured to determine a path from a first capture location of the captured image to a second capture location of the adapted task.

The method of any preceding clause, further including: providing a reviewer user interface on a user interface device; transmitting the captured image and/or the adapted task to the reviewer user interface for display; and determining the instructions for the adapted task based on user input received via the reviewer user interface.

The method of any preceding clause, further including: providing an inspection user interface on a user interface device; receiving user input via the inspection user interface for an inspection task; and determining and communicating machine instructions for the positioning system and one or more sensors of the sensor capture system based on the user input.

The method of any preceding clause, wherein the inspection user interface includes controls for a plurality of sensors of the sensor system and a plurality of positioning devices of the positioning system that can be selectively displayed concurrently on a display of the user interface device.

The method of any preceding clause, wherein the inspection user interface includes a representation of the component of the aircraft and representations of sensors of the sensor system that may be dragged and placed around the representation of the component.

The method of any preceding clause, wherein the positioning system includes an engine turning device configured to rotate a part within an engine.

The method of any preceding clause, wherein the part includes turbine blades, discs, blisks, and/or shafts.

The method of any preceding clause, wherein the inspection user interface includes a first slider for controlling a rotation of the engine turning device.

The method of any preceding clause, wherein the inspection user interface further includes an image of the engine for selecting an insertion location of a borescope.

The method of any preceding clause, further including: determining a capture timing for the sensor system based on a movement of the positioning system, and providing the machine instructions to the sensor system based on the capture timing.

The method of any preceding clause, wherein the positioning system includes a component positioning system and a sensor positioning system, and the processor is configured to control a motion of the component positioning system and the sensor positioning system concurrently to affect a relative position of the sensor system and the component for image captures.

The method of any preceding clause, wherein the user interface device includes a head-mounted display.

The method of any preceding clause, wherein the user input includes a movement and orientation of the head-mounted display, and the processor is configured to control a movement of the image capture device via the positioning system based on the movement and the orientation of the head-mounted display.

The method of any preceding clause, wherein the user input includes a touch input received on a touch sensitive display displaying an image of the component; and further including: determining one or more capture locations based on the touch input; determining a movement of one or more sensors of the image capture system based on the one or more capture locations; and communicating machine instructions to the image capture system to cause the movement of one or more sensors of the image capture system to the one or more capture locations.

The method of any preceding clause, wherein the touch input includes a tap motion, a drag motion, and/or a multi-touch pinch or stretch motion.

The method of any preceding clause, wherein a drag motion corresponds to a movement in a plane parallel to the image of the component, and a pinch or stretch motion corresponds to a forward or backward movement relative to the plane.

The method of any preceding clause, further including: displaying a previously captured image or a model of the component; receiving a user selection of an area of interest in the previously captured image as the user input; and determining a capture location and/or a capture configuration based on the area of interest.

The method of any preceding clause, wherein the capture location and the capture configuration are selected to focus and enlarge the area of interest.

The method of any preceding clause, wherein the inspection user interface includes a virtual, augmented, or mixed reality display.

The method of any preceding clause, wherein controls of the image capture system are displayed as overlays over a view of the sensor system.

The method of any preceding clause, wherein the user input includes motion input captured by a motion sensor.

The method of any preceding clause, wherein the user interface device includes a control column or a control stick for controlling a movement of the positioning system and/or for reviewing images captured by the image capture system.

The method of any preceding clause, further including: receiving a captured image from the image capture system with appended metadata; and selectively displaying a subset of available controls for the positioning system and the sensor system based on the metadata of the captured image.

The method of any preceding clause, wherein the subset of available controls is selected based on a location indicated and/or a part identifier in the metadata of the captured image.

The method of any preceding clause, further including: retrieving a captured image of a component captured by the image capture system and metadata associated with the captured image; retrieving supplemental information from a database based on the metadata associated with the image; providing an inspection user interface for display on a user interface device; and causing the image to be displayed along with the supplemental information in the inspection user interface.

The method of any preceding clause, wherein the metadata identifies a view or a part of the component, and the supplemental information includes technical or maintenance manual data associated with the part of the component.

The method of any preceding clause, wherein the metadata identifies an issue with a part of the component, and the supplemental information includes repair options associated with the issue.

The method of any preceding clause, further including: identifying a role associated with a user of the user interface device; retrieving a report template from a report template database based on the role associated with the user; and selectively populating the report template with captured images and associated metadata stored in an inspection database.

The method of any preceding clause, wherein the report template is generated by a report machine learning model trained on historical reports for a plurality of roles.

The method of any preceding clause, wherein the role is selected from an inspector, an administrator, a customer, a vendor, and a reviewer role.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims

1. An aircraft component inspection system including:
an image capture system including:
an image sensor system;
a positioning system; and
a processor communicatively coupled to the image sensor system and the positioning system, the processor being configured to:
determine an inspection recipe based at least on an identifier associated with a component of an aircraft being inspected;
identify a plurality of locations for performing image capture during an inspection workflow based on the inspection recipe;
provide machine instruction to the positioning system to position the image sensor system relative to the component based on the plurality of locations;
cause the image sensor system to capture images at the plurality of locations; and
store the images with captured location data in an inspection data database.

2. The aircraft component inspection system of claim 1, wherein the inspection recipe specifies an instructed image capture location associated with at least one required image, wherein the instructed image capture location includes a coordinate location relative to an inspection space, the component, or a part of the component.

3. The aircraft component inspection system of claim 1, wherein the inspection recipe specifies an instructed image capture orientation, including roll, pitch, and/or yaw of a sensor of the image sensor system.

4. The aircraft component inspection system of claim 1, wherein the inspection recipe specifies a view of the component for at least one required image, wherein the view of the component defines a size and/or an orientation of a portion of the component within an image frame.

5. The aircraft component inspection system of claim 1, wherein the processor is further configured to: provide capture instructions to the image capture system based on a location of the image capture system or a portion thereof.

6. The aircraft component inspection system of claim 1, wherein the positioning system includes a snake arm robot, and the machine instruction includes an instruction for controlling a movement of the snake arm robot.

7. The aircraft component inspection system of claim 1, wherein the processor is configured to validate the images captured prior to storing the images captured in the inspection data database.

8. The aircraft component inspection system of claim 7, wherein the images captured are validated based on a location of an image capture system and/or image quality.

9. The aircraft component inspection system of claim 1, wherein the processor is further configured to: determine an initial movement pattern for the positioning system based on the plurality of locations.

10. The aircraft component inspection system of claim 1, wherein the processor is configured to determine an image quality metric of the images;
determine an adjusted capture configuration based on the image quality metric; and
instruct the adjusted capture configuration to the image capture system to recapture at least one of the images.

11. The aircraft component inspection system of claim 1, wherein the inspection recipe identifies a portion of the component associated with a required image and the images captured are validated based on comparing the images captured with a computer model of the component, previously captured images from the component, and/or previously captured image from a similar component associated with the portion of the component.

12. The aircraft component inspection system of claim 1, wherein the processor is further configured to:
identify a plurality of parts of the component based on the images captured;
automatically determine a condition of a part based on at least one of the images captured; and
determine a subsequent task based on the condition of the part.

13. The aircraft component inspection system of claim 12, wherein the condition of the part is identified using a machine learning model.

14. The aircraft component inspection system of claim 1, wherein the processor is further configured to determine a location and orientation of the component, and wherein the plurality of locations are identified further based on the location and orientation of the component.

15. The aircraft component inspection system of claim 12, wherein the location and orientation of the component is determined based on markers on or near the component, wherein the markers include an optical marker, a color-coded marker, a shape-coded marker, a pattern coded marker, an embossed marker, an engraved marker, a sonar-readable marker, and/or a lidar-readable marker.

16. The aircraft component inspection system of claim 1, wherein the machine instruction to the positioning system is determined based on simulating movements of the positioning system with a computer model of the component.

17. The aircraft component inspection system of claim 1, wherein the inspection recipe and/or an adapted task for the inspection workflow is determined based on an engine identifier, an engine inspection history, an engine configuration record, an engine repair history, a customer-specified mission requirement, and/or an identified issue.

18. The aircraft component inspection system of claim 1, wherein a new capture location is determined based on an estimated position of an area of interest determined based on one or more of the images.

19. The aircraft component inspection system of claim 1, the image capture system further including:
a user interface device;
wherein the processor is further configured to:
provide an inspection user interface on the user interface device;
receive user input via the inspection user interface for an inspection task; and
determine and communicate machine instructions for the positioning system and one or more sensors of the image capture system based on the user input.

20. The aircraft component inspection system of claim 19, wherein the user input includes a touch input received on a touch sensitive display displaying an image of the component;
wherein the processor is further configured to:
determine one or more capture locations based on the touch input;
determine a movement of one or more sensors of the image capture system based on the one or more capture locations; and
communicate machine instructions to the image capture system to cause movement of one or more sensors of the image capture system to the one or more capture locations.
